(19) United States
(12) Patent Application Publication
(10) Pub. No.: US 2005/0266386 A1
(43) Pub. Date: Dec. 1, 2005

(54) Print media apparatus including stroke recognition

(75) Inventors: James Marggraff, Lafayette, CA (US); Larry Lynch, Los Gatos, CA (US); Kenneth Brown, Cupertino, CA (US); Peter Milford, Los Gatos, CA (US); Cheryl Aday, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 11/140,458

(22) Filed: May 27, 2005

Related U.S. Application Data
(60) Provisional application No. 60/575,557, filed on May 28, 2004.

(51) Int. Cl. G09B 5/00; G09B 3/00

(52) U.S. Cl. 434/317

(57) ABSTRACT

Devices, systems and methods are provided which enhance the learning process by means of interactive exercises and games which involve drawing input from a user. In particular, the present invention provides an interactive print media apparatus which includes a specialized writing instrument and at least one sheet on which the user is to write with the writing instrument. The user receives visual or auditory messages and prompts from the apparatus which instructs the user to perform tasks on the sheet using the writing instrument. In some embodiments, the user is instructed to draw one or more stroke marks within prescribed locations on the sheet and the apparatus provides feedback in relation to such markings. In other embodiments, the user is instructed to draw one or more stroke marks within prescribed locations on the sheet and the apparatus correlates the markings to known characters, such as letters, numbers or symbols.

### CROSS-REFERENCES TO RELATED APPLICATIONS

This application claims the benefit of priority of U.S. Provisional Patent Application No. 60/575,557, filed May 28, 2004, incorporated herein by reference for all purposes.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

Writing is a fundamental aspect of learning and communicating in our society. Although the introduction of computers and the adoption of word processing by younger and younger generations has introduced typing as a significant means of writing, the manual practice of handwriting is still a necessary skill and provides a unique aspect of the learning process.

Writing helps a student remember and learn about subjects. When learning a subject such as math, it is necessary for a student to write in order to learn about the subject. For example, a calculator can be used to multiply two double-digit numbers together. However, when using a calculator to multiply two numbers together, the student does not learn the process by which the calculator arrives at the answer. In order to learn the computational process performed by the calculator, a user must write down each step in the computational process. Writing is, in a sense, a dialog that the user is having with him/herself, and helps reinforce concepts being learned.

Traditionally, such learning has been achieved in a classroom or tutorial setting wherein the pupil is guided by an instructor. The pupil is provided with a sheet of plain paper to practice the skill of writing. Or, the pupil is provided with a worksheet having blanks for writing text or numbers in relation to elements printed on the page. In either case, the pupil is generally directed by the instructor as to the tasks to be performed on the page. And, in the case of the worksheet, the pupil may be required to read to be able to follow the instructions.

It is desired to provide a means for learning that does not require the continuous presence of an instructor or the ability to read. Further it is desired to provide a means for learning which is stimulating, engaging and fosters interest in learning. These objectives are addressed, individually and collectively, by the present invention.

### BRIEF SUMMARY OF THE INVENTION

The present invention provides devices, systems and methods which enhance the learning process by providing interactive exercises and games which involve drawing or writing input from a user. In particular, the present invention provides an interactive print media apparatus which includes a specialized writing instrument and at least one sheet on which the user is to write with the writing instrument. The user receives visual or auditory messages and prompts from the apparatus which instructs the user to perform tasks on the sheet using the writing instrument. In some embodiments, the user is instructed to draw one or more stroke marks within prescribed locations on the sheet and the apparatus provides feedback in relation to such markings. In other embodiments, the user is instructed to draw one or more stroke marks within prescribed locations on the sheet and the apparatus correlates the markings to known characters, such as letters, numbers or symbols. The apparatus may then use the inputted characters to further the learning process, such as to create exercises or games based on the characters. These examples are just a few of the aspects of the invention presented herein.

In preferred embodiments, an interactive print media apparatus is provided comprising a platform, an electronic position location system comprising a processor, a sheet including at least one prescribed location, a writing instrument operatively coupled with the electronic position location system, and a memory device operatively coupled to the processor. The platform has a surface upon which the sheet is to placed so that the sheet is held in predetermined arrangement. When the user touches or writes within the at least one prescribed location with the writing instrument, the electronic position location system is able to monitor such movements of the writing instrument.

In some of these embodiments, the memory device comprises a code for at least one output wherein the at least one output indicates drawing of a stroke mark with the writing instrument within the at least one prescribed location on the sheet. The at least one output may include a sound that is heard by a user coincident with the drawing of the stroke mark. For example, the sound may include a purring sound. This reassures the user that the apparatus is sensing the movements of the writing instrument and provides incentive to continue writing and enjoying the interactive sounds.

Typically the prescribed locations on the sheet are indicated by at least one print element. The print element may have any suitable shape or form and often includes a delineation or outline of the prescribed location itself. In some embodiments, the at least one print element comprises a pathway wherein the pathway indicates the at least one prescribed location. The user may hear a sound, such as a melody, as the writing instrument is traced along the pathway. Or, a plurality of pathways may be present forming a maze.

In some embodiments the print elements comprise a letter shape wherein the letter shape indicates the at least one prescribed location. The user may be instructed to trace the letter shape with the writing instrument. As the user is drawing within the prescribed location, the user may hear a sound correlating to the letter shape. Alternatively or in addition, the print elements may comprise a number shape wherein the number shape indicates the at least one prescribed location. The user may be instructed to trace the number shape with the writing instrument. As the user is drawing within the prescribed location, the user may hear a sound correlating to the number shape. It may be appreciated that such print elements may also include symbols and other shapes or characters. It may also be appreciated that the user may receive an output indicating drawing of a stroke mark outside of the at least one prescribed location on the sheet. Thus, the user is guided to make the appropriate markings on the sheet with the writing instrument.

In other of the embodiments the memory device comprises code for correlating drawing of stroke marks with the writing instrument within one of the at least one prescribed locations to a character. Such characters typically include letters, numbers and/or symbols. Thus, the interactive print media apparatus is able to recognize writing that is input by the user in the prescribed locations. In most embodiments, the sheet includes at least one print element indicating the location of the at least one prescribed location. Such print elements may have any suitable shape, including a line, square, rectangle, circle, oval, triangle or polygon. Each print element may indicate a single prescribed location or at least one of print elements may indicate an outer boundary of a plurality of adjacent prescribed locations.

The code may also provide a sound related to the recognized character. When the character comprises a letter, the sound may include, for example, a pronunciation of the letter or a phoneme of the letter. When the character comprises a number or a symbol, the sound may include, for example, a pronunciation of the name of the number or the name of the symbol, respectively.

To assist the print media apparatus in recognizing the stroke marks, the user may select a done print element or a “done dot” when the user has completed the drawing of stroke marks in a prescribed location and in the correct sequence. In some embodiments, a processor and computer code in the apparatus correlates the drawing of stroke marks in response to selection of a done print element on the sheet by the user with the writing instrument. Thus, the electronics in the apparatus are signaled that the user is done writing and is ready to receive a response. The done print element may have any shape, such as a dot, circle, oval, line, square, triangle, polygon or swirl. In other embodiments, the apparatus correlates the drawing of stroke marks automatically after a prescribed time period in which the user has not made any additional stroke marks.

In some embodiments, the memory device comprises code that correlates characters drawn within a plurality of prescribed locations to one or more words. In these embodiments, there may also be code for providing at least one sound comprising a pronunciation of the one or more words. Likewise, in some embodiments, there may be code for correlating characters drawn within a plurality of prescribed locations to one or more numbers.

Methods of using the interactive print media apparatus are also provided. Other objects and advantages of the present invention will become apparent from the detailed description to follow, together with the accompanying drawings.

### BRIEF DESCRIPTION OF THE DRAWINGS

FIG. 1 illustrates an embodiment of an interactive print media apparatus.

FIGS. 2-3 illustrate a platform with first and second housing portions in open and closed configurations.

FIG. 4(a) illustrates an exploded view of a platform unit.

FIG. 4(b) illustrates an upper antenna and a lower antenna separated by an insulating sheet.

FIG. 4(c) depicts a detailed view of a first antenna element.

FIG. 5 is a schematic cross-section of a detection stylus in use detecting an electromagnetic field generated by the first antenna element.

FIG. 6 is a schematic block diagram of a processor and the first element elements.

FIG. 7 illustrates an exemplary zone of the present invention.

FIG. 8A illustrates an embodiment of a print element having the shape of the letter “A” and three zones overlaying portions of the print element.

FIG. 8B illustrates an embodiment of a sheet of print medium having print elements such as shown in FIG. 8A.

FIG. 9A illustrates an embodiment wherein the print element has the shape of the letter “A” which delineates the zones.

FIG. 9B illustrates an embodiment of sheets of print medium, each sheet having print elements with shapes of different letters of the English alphabet.

FIG. 10 illustrates an embodiment of a sheet of print medium having print elements comprised of dashed lines in the shape of the number “2”.

FIG. 11 illustrates an embodiment of a sheet of print medium having print elements comprised of dashed lines in the shape of both numbers and symbols.

FIG. 12 illustrates an embodiment of a sheet of print medium having print elements comprising a maze having pathways and one or more zones overlaying the pathways.

FIGS. 13-14 illustrate embodiments in which zones form pathways between print elements.

FIG. 15 illustrates an embodiment of a character recognition field having a rectangular shape and a letter drawn therein.

FIG. 16 illustrates fields arranged in a group for recognition of the stroke marks as a grouped entity, such as a word.

FIG. 17 illustrates the presence of more than one letter drawn in a field.

FIG. 18 illustrates an embodiment of a character recognition field having a rectangular shape and a number drawn therein.

FIG. 19 illustrates fields arranged in a group for recognition of the stroke marks as a grouped entity, such as a dollar amount.

FIG. 20 illustrates the presence of more than one number drawn in a field.

FIG. 21 illustrates the use of fields to perform mathematical computations.

FIG. 22 illustrates a done print element in the shape of a star and a triangular symbol drawn in a field.

FIG. 23 illustrates a done print element in the shape of a swirl and a happy face symbol drawn in the field.

FIG. 24 illustrates an embodiment of two sheets of print medium having print elements and character recognition fields to create interactive mathematical equations.

FIGS. 25-26 illustrate embodiments of a sheet of print medium having a tens field and a ones field to assist the user in learning number values.

FIGS. 27-28 illustrate embodiments of a sheet of print medium having character recognition fields to create interactive games.

### DETAILED DESCRIPTION OF THE INVENTION

I. Print Media Apparatus

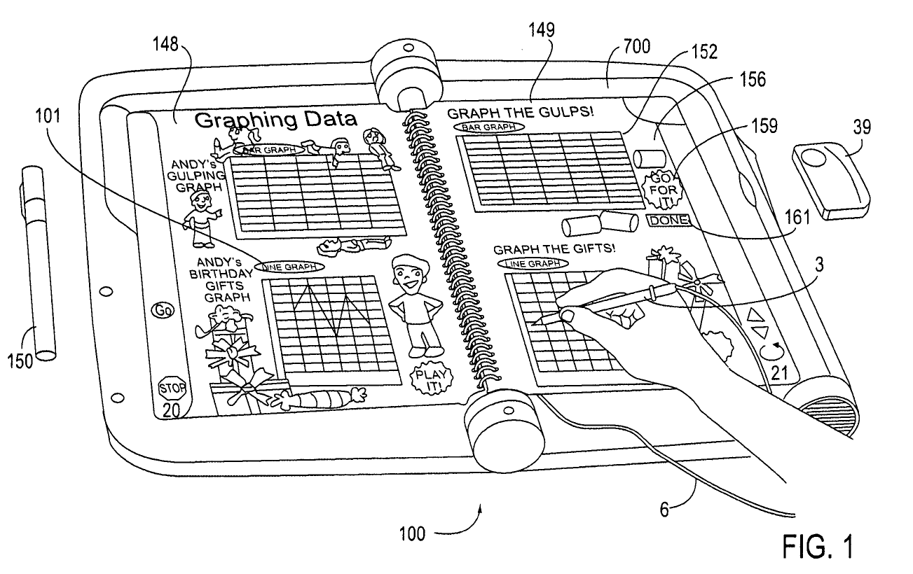

FIG. 1 illustrates an embodiment of an interactive print media apparatus 100. The interactive print media apparatus 100 includes a platform 700 having a surface, a stylus 3 that is mechanically and electronically coupled to the platform 700 via a wire 6, and a memory device 39 in the form of a data cartridge. A print medium 156 is disposed on the surface of the platform 700 as shown. In this embodiment, the print medium 156 comprises a spiral bound booklet having a plurality of sheets.

A. Electronic Position Location System

An electronic position location system is typically disposed within the platform 700 of the interactive print media apparatus 100. The system may include a processor and array of electrical elements (not shown) that are underneath the surface of the platform. The electrical elements can be antennas such as those described in U.S. Pat. Nos. 5,877,458 or 5,686,705, and U.S. patent application Ser. No. 09/574,599 (now U.S. Pat. No. 6,661,405) and No. 60/200,725. All of these patents and patent applications are incorporated herein by reference in their entirety for all purposes. The antennas can transmit signals that can be received by the stylus 3. The stylus 3 can have a receiving antenna (this may be part of the system). When the stylus 3 is over the surface, the stylus 3 receives a particular signal that is associated with the electrical element underneath the stylus 3. Then, the position of the stylus 3 relative to the surface can be determined. The stylus 3 could be used to interact with the various print elements on the print medium that is on the platform 700. The electrical elements may be transmitting antennas that regularly transmit signals that are received by the stylus 3, or may be receiving antennas that receive a signal from the stylus 3. Exemplary embodiments of the stylus 3 are provided in U.S. patent application Ser. No. 10/457,981 filed on Jun. 9, 2003 (Attorney Docket Number 020824-004700US) which is herein incorporated by reference in its entirety. In some embodiments, the stylus also includes a writing element which allows the user to write on the print medium. Any suitable writing element can be used in the stylus, such as pencils, chalk, standing pencil leads, pens, pen refill cartridges, markers, crayons, etc. Such writing elements will be discussed in further detail in later sections.

Electrical elements that are transmitting antennas are described in detail. However, in other embodiments, pressure-sensitive switches could be used. Apparatuses with pressure sensitive switches are described in U.S. patent application Ser. No. 09/886,401, filed on Jun. 20, 2001, now U.S. Pat. No. 6,608,618, which is herein incorporated by reference in its entirety.

Some or all of the electrical elements in the array of electrical elements can be pre-assigned to retrieve and provide specific outputs for the user so that a user receives a particular output when selecting a print element that is located over a particular electrical element. In addition, some of the electrical elements can be pre-assigned to indicate that a different sheet with different print elements is on the base unit when they are activated. For example, once an electrical element underneath a “Go” circle on a sheet is activated, the electronics in the platform 700 can determine which page of a multi-page print medium is being displayed to the user. A processor can reprogram the interactive apparatus so that the electrical elements in the array are re-assigned to retrieve outputs associated with the print elements in the new sheet.

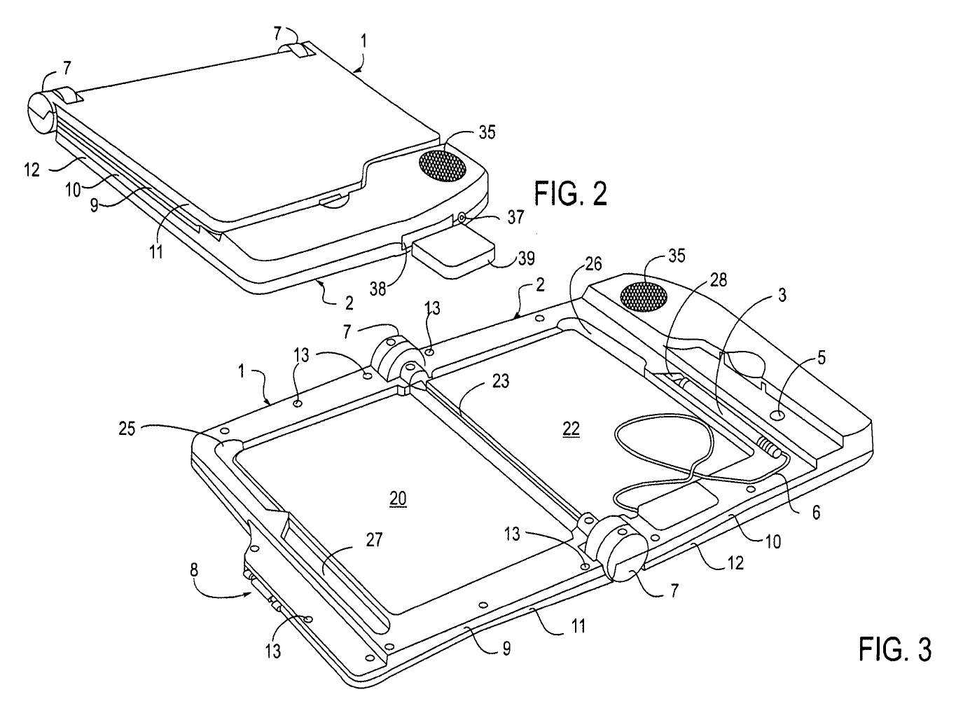

Some components of a preferred interactive print media apparatus are shown in FIGS. 2-6. Other features of a suitable apparatus are described in U.S. patent application Ser. No. 09/777,262 (now U.S. Pat. No. 6,668,156), filed on Feb. 5, 2001, which is herein incorporated by reference for all purposes. FIGS. 2 and 3 show a platform with first and second housing portions 1, 2 in open and closed configurations. A pair of hinges 7 connects the first and second housing portions 1, 2 of the platform. A spring-loaded latch 8 holds the housing portions 1, 2 together when closed. Both the first housing portion 1 and the second housing portion 2 comprise an upper section 9, 10 and a lower section 11, 12. The upper sections 9, 10 of the first and second housings 1, 2 are fixed to their respective lower sections 11, 12 with screws 13.

The upper and lower sections 9, 11 of the first housing portion 1 define a cavity within which is provided a first transmitting antenna element (not shown). The upper and lower sections 10, 12 of the second housing 2 also define a cavity. The second housing portion 2 can house a loudspeaker and processor.

The upper surface of the upper section 9 of the first housing portion 1 has a rectangular recess 20. An identical rectangular recess 22 is provided on the upper surface of the upper section 10 of the second housing portion 2. These rectangular recesses 20, 22 lie adjacent to one another with the long sides of the rectangular recesses being separated by a small gap 23. Together the rectangular recesses 20, 22 provide a surface on which a book having, for example, a spiral binding (not shown) can rest. Transmitting first antenna elements are located immediately beneath these rectangular recesses 20, 22. Provided along the edges of the rectangular recesses 20, 22 remote from the gap 23 are thumb grooves 25, 26. The thumb grooves 25, 26 provide means by which a user is able to access the corners of pages of a book resting on the rectangular recesses 20, 22.

Adjacent to the thumb grooves 25, 26 further along the long sides of the rectangular recesses 20, 22 are a pair of stylus rests 27, 28. These stylus rests 27, 28 are arranged to receive a detection stylus 3. Lying in the stylus rest 28 in the upper section 10 of the second housing portion 2 is a detection stylus 3. The detection stylus 3 is connected via a wire 6 to the processor located within the part of the cavity defined by the second housing 2.

Provided in the upper section 10 of the second housing 2 is a loudspeaker grill 35, which is provided immediately above the loudspeaker, housed within the cavity. This loudspeaker grill 35 is provided at the corner of the upper section 10 of the second housing 2 next to the thumb groove 26.

In the portion of the upper section 10 of the second housing 2 adjacent to the stylus rest 28 there is an ON/OFF button 5. The ON/OFF button 5 is connected to the processor within the second housing portion 2 and provides means for activating the processor and the transmitting first antenna elements within the platform unit.

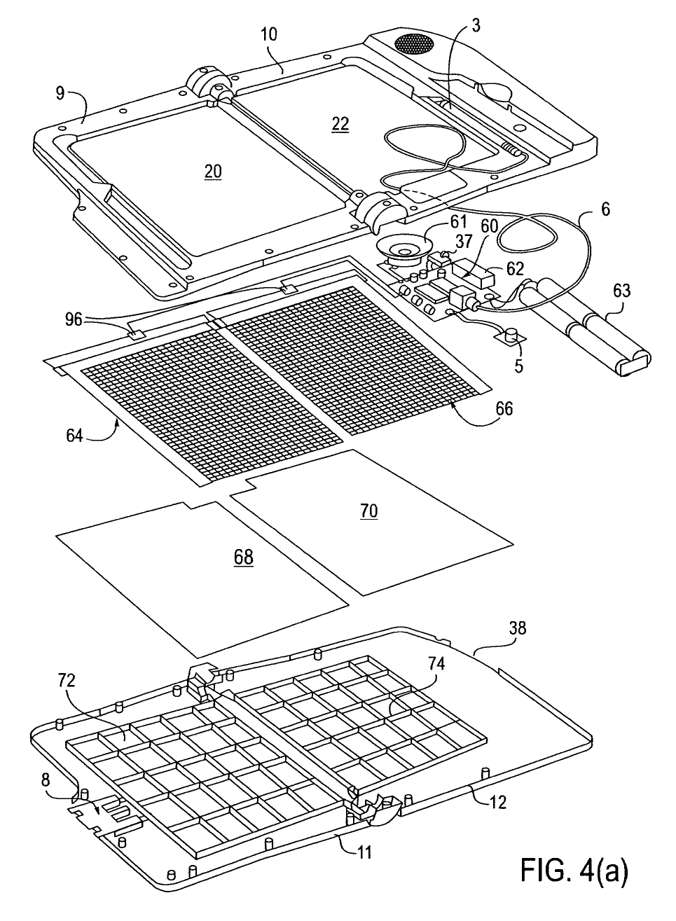

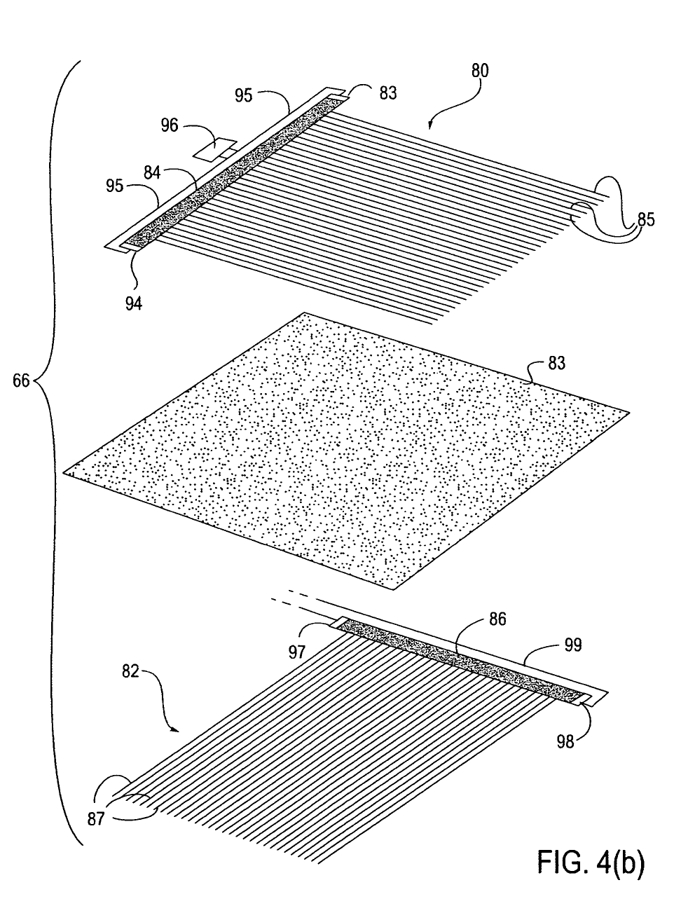

The second housing portion 2 includes a headphone jack 37 and a slot 38 arranged to receive a memory device 39 having the form of a cartridge. Provided within the slot 38 is a mating interface (not shown in FIGS. 3 and 4) for receiving the memory device 39. By inserting the memory device 39 into the slot 38, the memory device 39 fits into the mating interface. The processor in the second housing portion 2 can access data in the memory device 39.

FIG. 4(a) is an exploded view of the platform unit. The processor 60 is connected to the loudspeaker 61, the ON/OFF button 5 and the headphone jack 37 and via the wire 6 to the detection stylus 3. Further the processor 60 is connected to a mating interface 62 for receiving a memory device 39 and a set of batteries 63 for powering the processor 60.

Two first antenna elements 64, 66 are connected via cables 67 to the processor 60 enabling the processor 60 to control the timing of signals generated by the first transmitting antenna elements 64, 66. The first antenna elements 64, 66 are provided directly beneath rectangular recesses 20, 22. They are sandwiched between the underside of the upper sections 9, 10 of the first and second housings 1, 2 defining the rectangular recesses 20, 22 and sheets of cardboard 68, 70. They rest upon supports 72, 74 on the inside surfaces of the lower sections 11, 12 of the first and second housing portions 1, 2.

Referring to FIG. 4(b), each first antenna element 64, 66 comprises an upper antenna 80 and a lower antenna 82 separated by an insulating acetate sheet 83. The upper antenna 80 comprises a resistive strip 84 formed by printed conductive ink, that extends along one of the short sides of a rectangle corresponding to the area defined by the rectangular recess 20, 22 beneath which the first antenna element is located. Extending away from the resistive strip 84 at right angles to the resistive strip 84 is a plurality of conductive fingers 85 also comprising printed conductive ink. These conductive fingers 85 are spaced equidistantly from one another along the length of the resistive strip 84 and run parallel to one another. The conductive fingers 85 extend from the resistive strip to a length corresponding to the extent of the long side of the rectangular recesses 20, 22.

The lower antenna 82 is disposed on the opposite side of the insulating acetate sheet 83 and comprises a second resistive strip 86. This second resistive strip 86 extends along the periphery of the area along the long side defined by the rectangular recesses 20, 22 beneath which the antenna is located. In a similar arrangement to the arrangement of the upper antenna 80, extending away at right angles from the resistive strip 86 of the lower antenna 82 are a plurality of conductive fingers 87 spaced equidistant from one another along the length of the conductive strip 86. The number of conductive fingers 85, 87 can vary depending on the desired resolution.

The conductive fingers 85, 87 of the second antenna arrangement 66 within the second housing portion 2 form an orthogonal lattice of equally spaced conductive fingers 85, 87 that extends across the entirety of the area defined by the rectangular recess 22 in the upper section 10 of the second housing portion 2 with conductive strips 84, 86 extending beyond the periphery of this area. Similarly, the conductive fingers 85, 87 of the first antenna element 64 within the first housing portion 1 define an orthogonal lattice of equally spaced conductive fingers 85, 87 extending beneath the extent of the rectangular recess 20 in the upper section 11 of the first housing portion 1. These orthogonal lattices of conductive fingers 85, 87 are used to generate electromagnetic fields in the vicinity of the surface of the recesses 20, 22 which can be detected by the detection stylus 3. They are used to determine which portions of a two-dimensional book in the rectangular recesses 20, 22 has been selected utilizing the detection stylus 3.

FIG. 4(c) is a detailed plan view of a first antenna element 66. FIG. 4(c) shows the shape of the conductive fingers 85, 87 of the first antenna element 66. When the conductive fingers 85 extend away from the conductive strip 84 of the upper antenna 80, each of the conductive fingers 85 is identical to one another and comprises a substantially rectangular strip, which has narrower portions 90 wherever the conductive finger 85 overlies one of the conductive fingers 87 of the lower antenna 82. Each conductive finger 87 of the lower antenna 82 includes a rectangular strip with wing portions 92 where the conductive finger 87 is not covered by the conductive fingers 85 of the upper antenna 80.

Provided at either end of the resistive strip 84 of the upper antenna 80 are first 93 and second 94 electrical contacts that are connected via conductive wiring 95 to an interface 96 and hence via the cable 67 to the processor 60. Similar first 97 and second 98 electrical contacts are provided at either end of the resistive strip 86 of the lower antenna 82. These contacts 97, 98 are also connected via conductive wiring 99 to the interface 96, hence via the cable 67 to the processor 60. As in the case of the upper 80 and lower 82 antennas these electrical contacts 93, 94, 97, 98 and the conductive wiring 95, 99 also comprise conductive ink printed on the surface of the acetate sheet 83.

The electrical contacts 93, 94, 97, 98 and conductive wiring 95, 99 enable electrical signals to be applied to the resistive strips 84, 86. When alternating signals are applied to the resistive strips 84, 86 this causes the conductive fingers 85, 87 connected to the resistive strips 84, 85 to generate an alternating electromagnetic field, which can be detected by the detection stylus 3. The resistive strips 84, 86 may comprise a voltage divider strip that allows signals of different voltages to transmit from each of the conductive fingers 85, 87. Further details about the voltage divider strip are in U.S. patent application Ser. No. 09/574,499, filed May 19, 2000. In this U.S. Patent Application, the voltage divider strip includes a number of resistors in series. These resistors allow the conductive fingers 85, 87 to transmit signals of different voltages. Of course, other types of antenna systems may be used. For example, other embodiments that use capacitive division are described in U.S. patent application Ser. No. 10/222,205, filed on Aug. 16, 2002.

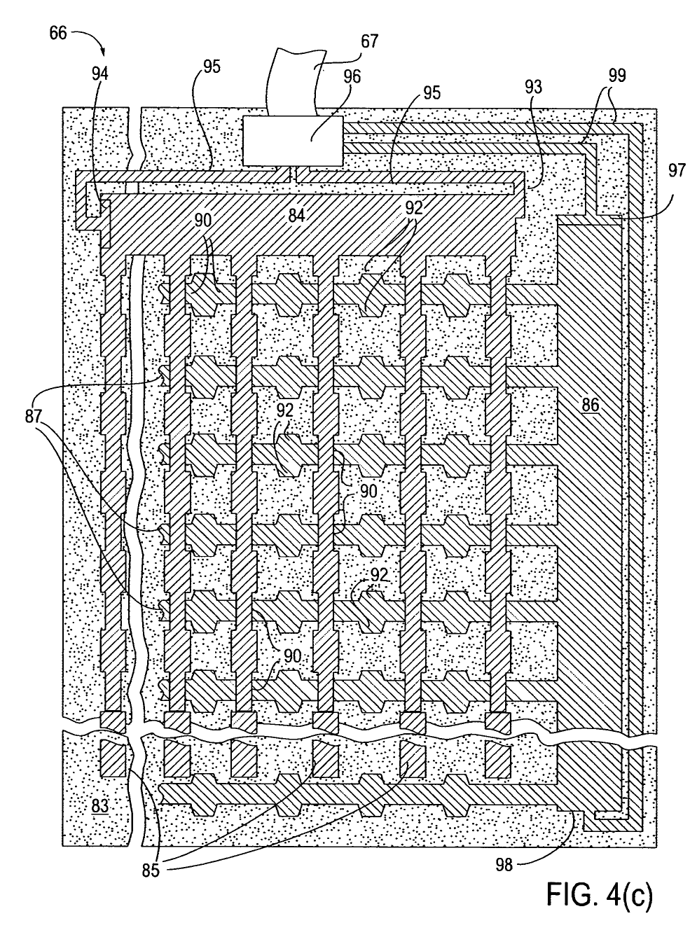

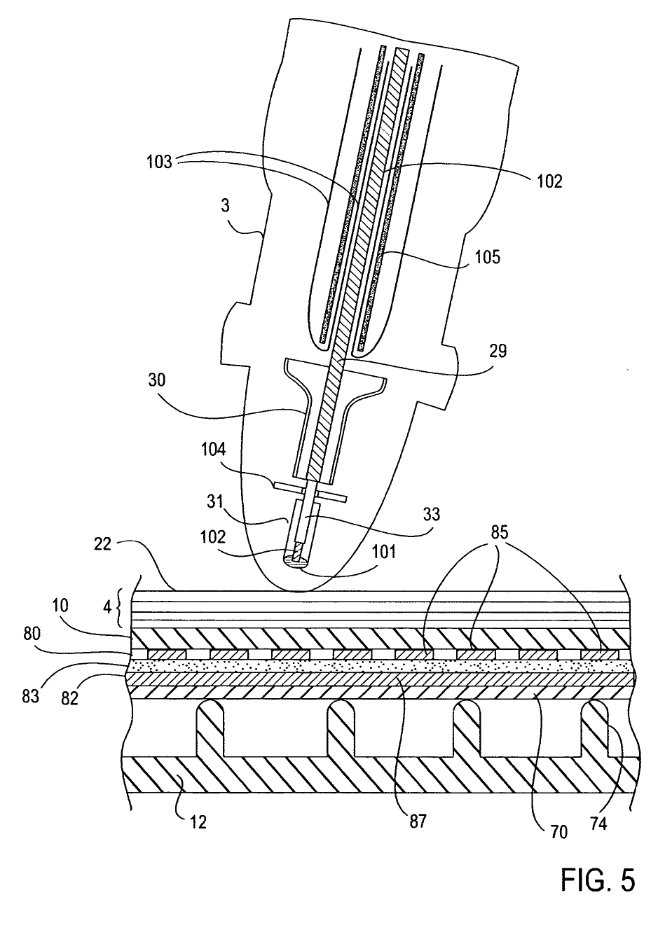

FIG. 5 is a schematic cross section of the detection stylus 3 in use detecting an electromagnetic field generated by the first antenna element 66. The detection stylus 3 is shown resting on the surface of the page of a book 4 that lies within the recess 22 in the upper section 10 of the second housing 2. Immediately beneath the upper section 10 of the second housing 2 lie the conducting fingers 85 of the upper antenna 80 of the first antenna element 66. These conductive fingers 85 are provided above the acetate insulating sheet 83 that separates the upper antenna 80 from the lower antenna 82. Disposed on the opposite side of the acetate sheet 83 are the conductive fingers 87 of the lower antenna 82. Beneath the lower antenna 82 lies the protective sheet of card 70 that it supported by the supports 74 of the lower section 12 of the second housing 2.

The distal end of the detection stylus 3 includes a brass ferule 30 (reflector) which is separated from a small ferule 31 by an insulating washer 104. The small ferule 31 is connected via a solder bead 101 to a center conductor 102, such as a copper wire. The center conductor 102 is connected via wire 6 to the processor 60. An insulating jacket 33 surrounds the center conductor 102 within the small ferule 31 and a conductive jacket 29 surrounds the center conductor 102 as shown. The center conductor 102 extends through the center of this insulating washer 104. Shielding 105 and braid conductor 103 extend within the detection stylus 3, as shown.

Referring to FIGS. 4(a)-4(c) and 5, alternating electric signals are applied via the electrical contacts 93, 94, 97, 98 to the resistive strips 84, 86 of the upper and lower antennas 80, 82. This causes an alternating electromagnetic field to be generated in the vicinity of the antennas 80, 82. This alternating electromagnetic field induces a voltage on the brass ferule 30 of the detection stylus 3 when the detection stylus 3 rests on the surface of a book 4 within the recess 22 adjacent to the antennas 80, 82. This electric signal is then passed via the conductor 102 to the processor 60. The insulating washer 104 and shielding 105 prevent electrical signals from being induced within the conductor 102 other than by variations in the electromagnetic field in the vicinity of the brass ferrule 30.

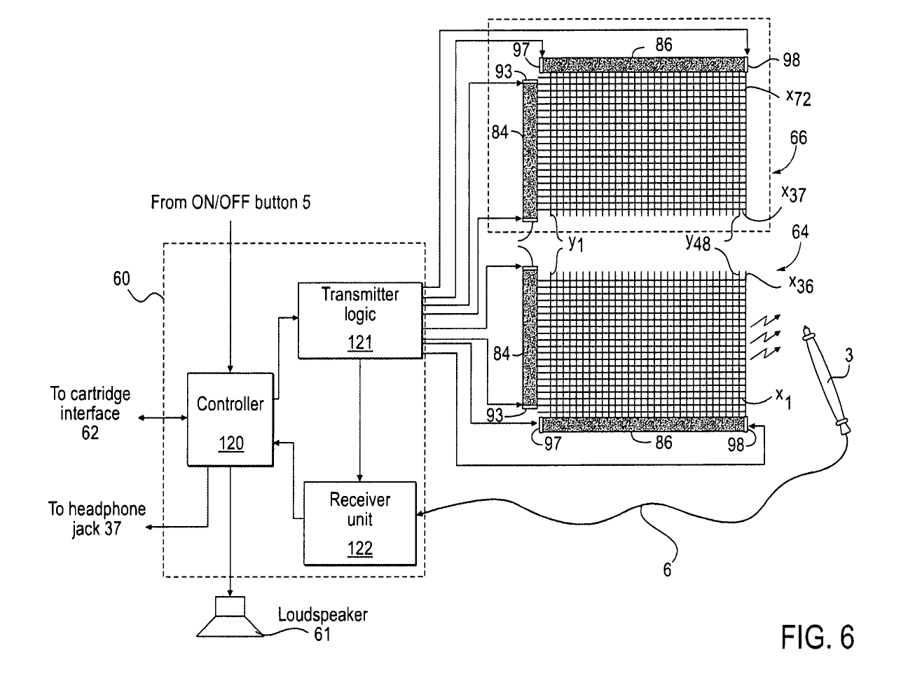

FIG. 6 is a schematic block diagram of the processor 60 and the first antenna elements 64, 66. The processor 60 comprises a controller unit 120, transmitter logic 121 and a receiver unit 122. The processor 60 may include a signal driver and a signal processor. The controller unit 120 is connected via the transmitter logic 121 to the first antenna elements 64, 66. The controller unit 120 is also connected via the receiver unit 122 via the wire 6 to the detection stylus 3. The transmitter logic 121 and receiver unit 122 are also connected to each other directly. The controller unit 120 is also connected to the headphone jack 37, the loudspeaker 61, the cartridge mating interface 62 and the ON/OFF button 5.

When the ON/OFF button 5 is pressed, this is detected by the controller unit 120 which causes the transmitter logic 121 to be activated. The transmitter logic 121 then applies electric signals to the electrical contacts 93, 94, 97, 98 of the first antenna elements 64, 66 in a sequence of frames. Referring to FIG. 4(c), in these frames, each lasting approximately 3 milliseconds, predetermined electrical signals are applied to the contacts 93, 94, 97, 98 of the transmitting antenna arrangements 62, 64. At the end of each frame a different set of signals are then applied to the contacts 93, 94, 97, 98.

In the course of a frame, an electromagnetic field is generated in the vicinity of the rectangular recesses 20, 22 in the upper sections 9, 10 in the first and second housing portions 1, 2. These electromagnetic fields induce voltage potentials in the brass ferule 30 of detection stylus 3. This signal is then passed via the wire 6 to the receiver unit 122. In one example, the voltages applied to the contacts 93, 94, 97, 98 may range between plus three volts and minus three volts. The voltage induced within the brass ferule 30 can be about 0.5 millivolts. The receiver unit 122 then processes the induced voltage and a processed signal is then passed to the controller unit 120.

The controller unit 120 then converts the processed signals received from the receiver unit 122 into signals identifying the coordinates of the portion of the page of the print media or book 4 at which the detection stylus 3 is currently located. These coordinates are then used to select an appropriate sound stored within a sound memory either provided as part of the controller unit 120 or alternatively a sound memory provided as a memory chip within a memory device 39 inserted within the cartridge interface 62. The appropriate sound is then output via the loudspeaker 61 or to a set of headphones via the headphone jack 37.

B. Memory Device

As mentioned previously, the memory device 39 communicates with the electronic position location system in the platform 700. The memory device 39 may contain code for various audio outputs corresponding to various print elements in the print medium 156. Such audio outputs may include, for example, interpretations of print elements or sound effects associated with print elements on a print medium. In this embodiment, the memory device 39 is in the form of a data cartridge that is external to the platform 700 which can plug into a recess (not shown) in the platform 700. When it is plugged into the platform 700, the memory device 39 is in communication with the electronic position location system in the platform 700. Alternatively, the memory device could be internal to the platform 700 and in communication with the electronic position location system in the platform 700. For example, the memory device may comprise any suitable combination of internal or external ROM (read only memory) units, EEPROM (electronically erasable programmable read only memory) units, PROM (programmable read only memory) units, etc. The memory device may also have other forms (e.g., a memory stick, CD-ROM, etc.).

C. Writing Instrument

Exemplary embodiments of the writing instrument or stylus are provided in U.S. patent application Ser. No. 10/457,981 filed on Jun. 9, 2003 which is herein incorporated by reference in its entirety. In these embodiments, the stylus includes a writing element which allows the user to write on the print medium. Any suitable writing element can be used in the stylus. Exemplary writing elements include erasable writing materials such as pencil lead or erasable ink and non-erasable writing materials. Specific examples of writing elements include pencils (mechanical and non mechanical), wood pencils, chalk, automatic pencils, free-standing pencil leads, pens, pen refill cartridges, markers, crayons, etc. Preferably, the writing element is an automatic pencil with an automatic lead feeding mechanism. A preferred writing element is a customized pencil similar to an automatic pencil sold under the tradename “Sensematic”, which is commercially available from Dixon Ticonderoga, Inc.

The writing material (e.g., ink, pencil lead, etc.) that is used in the writing element is preferably non-conductive. The use of a non-conductive writing material can reduce the likelihood that the writing material will not interfere with the signal transmitting antenna under the surface of the housing of the electrographic position location apparatus. Also, a conductive writing material that is inside of the stylus may interfere with signals that are being transmitted by the stylus or received by the stylus. In any case, a separate ground shield is typically included for the writing element in the stylus.

The writing element in the stylus may include a first end portion proximate to the distal end region of the stylus and a second end portion proximate to the proximal end region of the stylus. The first end portion of the writing element corresponds to the portion of the writing element that is used for writing.

In some embodiments, the writing element may be a retractable writing element. Accordingly, the writing element in the stylus may or may not be capable of writing, depending on the user's desire. The tip of the writing element may be inside of the stylus when the stylus is in a retracted position. The tip of the writing element may extend outwardly from the distal end of the stylus when the writing element is in an extended position so that the user may write with the stylus. The stylus can be capable of receiving (or transmitting) an electromagnetic signal when the writing element is either in an extended position or a retracted position.

D. Print Medium

A print medium 156 in the form of a book is shown in FIG. 1. However, any suitable print medium can be used. For example, the print medium can be a single sheet (e.g., like a worksheet or photograph) or a book. The book can have any suitable number of pages, and may include any suitable type of binder, such as a spiral or a ring binder. Each sheet (e.g., in a book) may also have any suitable size. For example, each sheet can have a standard size such as 5×7, 8.5×11, 8×14, or A4. Further, the print medium can comprise plastic, paper, cardboard, etc., and can be colored or uncolored.

The print medium 156 is preferably an erasable print medium. In such embodiments, a user can write on the sheets of the print medium 156 and can later erase any markings made on the sheets of the print medium 156 so that they can be re-used. In preferred embodiments, the erasable print medium 156 comprises one or more sheets of paper, each of which is flood coated with a clear material which acts as a barrier coat, such as a clear ultraviolet cured mat overprint. In other embodiments, the print medium 156 comprises paper which has been laminated or sealed with a polymeric material, such as an acetate material, a polyester sheet such as Mylar™, or any suitable polymeric sheet. In other embodiments, the print medium 156 comprises plastic sheets without paper. In yet another embodiment, a normal sheet of paper may be used in combination with an erasable pencil.

In some embodiments, the print medium 156 may comprise a transparent sheet (e.g., made of acetate or Mylar™) that may be layered over a sheet having graphics or other printing on it. For example, an acetate or Mylar™ sheet, or other transparent material, could be bound at one edge, say a top edge, to the back cover of the book and flipped over another page with print elements. The user can see the print elements through the transparent sheet. Alternatively, a loose transparent sheet could be inserted in the binding in front of any page having an image where the user is expected to write. Using an erasable print medium and an erasable writing element has advantages. For example, a print medium with instructions and prescribed locations for writing can be reused many times if erasable materials and media are used.

Any suitable number or types of print elements can be on the one or more sheets of the print medium. Exemplary print elements include drawings and portions thereof, words, phrases, portions of words, phonograms, shapes, pictures (e.g., photographs) and portions thereof, characters, symbols, maps, letters, numbers, shapes, drawings, blanks, boxes, lines, arrays of characters (e.g., an array of letters, numbers, or both) etc. As used herein, “characters” can include numbers, shapes (e.g., circles, squares), foreign language markings (e.g., kanji or Chinese characters), etc.

In addition to print elements, the print media includes prescribed locations. As used herein, a “prescribed location” refers to a specifically designated area on a sheet where the user is directed to write, typically in response to a prompt from the interactive print media apparatus. The prescribed location can have one or more print elements associated with it. For example, the one or more print elements at the prescribed location can include one or more boxes, indicia, pictures, blanks, or spaces that are printed on the sheet; these may be referred to as “write on print elements”. The user can write numbers, letters, words, lines, etc. in the boxes, blanks, or spaces. In another example, the print elements on a sheet could comprise dots. The user may be prompted to draw lines between specific sets or pairs of dots. In yet another example, the prescribed location on one sheet may be associated with a print element on another sheet. For example, the sheet with the prescribed location could be a transparent sheet (with or without printing) that overlays with a second sheet with print elements. The print elements can be seen through the transparent sheet. The user may write in the prescribed locations on the transparent sheet corresponding to print elements underneath the transparent sheet.

The sheet with the prescribed locations is preferably in a print medium containing one or more sheets. The print medium and any outputs that are produced in conjunction with print elements in the print medium may be designed to specifically educate the user about a predetermined subject. For example, the print medium and outputs can teach a user about colors, letters, shapes, numbers, word pronunciation, phonics, reading, current events, songs, general math, algebra, subtraction, multiplication, division, fractions, decimals, geometry, science, geography, history, spelling, grammar, the names and sounds of musical instruments, people, places, nature, music, sports, letters, numbers, counting, social studies, creative expression, languages such as English, Spanish, and Chinese, etc. The skills taught by the interactive print media apparatus can include recognition skills (e.g., number and letter recognition) and logic skills.

In some embodiments, there can be “assistance print elements” on the pages of a print medium. An “assistance print element” is a print element that provides assistance to the user after the user selects it (e.g., using a stylus). Assistance print elements may be located proximate to prescribed locations where the user writes. Because of its proximity to a prescribed location, a user knows that the user can select the assistance print element if the user needs help writing in the prescribed location. After selecting an assistance print element, the user may receive an audio output that comprises a hint, encouragement, or an answer that relates to what the user is supposed to write. There can also be “game print elements” on the one or more sheets in the print medium. A game print element causes the interactive print media apparatus to play a game after the user selects it.

E. Output Device

An output device (not shown) can be in the platform 700 and is also operationally coupled to the electronic position location system. The output device can be an audio output device, such as a speaker or an earphone jack, or alternatively be a visual output device, such as a display screen. An output such as an audio prompt may be used to prompt the user to write in the prescribed location on the sheet. The outputs provided by the interactive print media apparatus may include visual and/or audio outputs. Exemplary outputs can include letters, stories, numbers, words, phrases, jokes, music, questions, answers, prompts, sound effects, facts, etc. Audio outputs are preferred as they supplement and reinforce visual information such as letters, pictures, and numbers that may be on the sheets of the print medium. Therefore, outputs will be described in terms of audio outputs hereinafter with an appreciation that such outputs may additionally or alternatively include visual outputs.

II. Stroke Recognition

The print medium includes one or more prescribed locations which are areas specifically designated for writing by the user. In some embodiments, when the user creates lines, marks, or strokes within the one or more prescribed locations, the print media apparatus recognizes such activity and provides an audio output. These prescribed locations may be considered “zones” and may be indicated on the print medium by a print element.

A. Zones

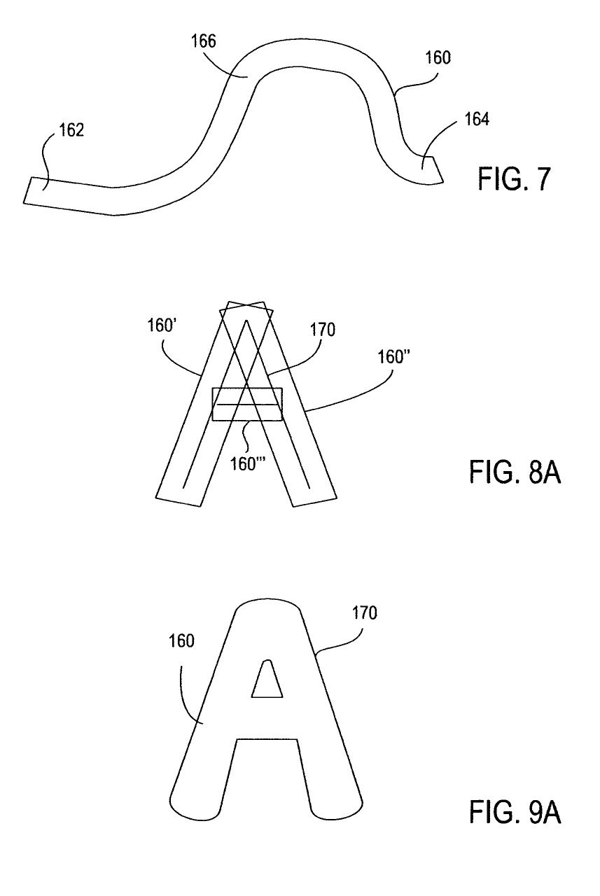

Zones are areas within which the user is intended to draw at least a line or stroke. Typically, the zones are designed to follow a single line or stroke drawn by the user, such as a continuous stroke drawn along a path or pathway. Consequently, zones typically have an elongate shape having curvatures and/or straight portions in any combination. FIG. 7 provides an exemplary zone 160. Here, the zone 160 has a first end 162, a second end 164 and an elongate section 166 therebetween. The user may be directed to draw a line within the zone 160 from the first end 162 to the second end 164. When the writing instrument is drawing a line or stroke mark within the zone 160, the position location system recognizes that the writing instrument is drawing within the zone and the user hears an appropriate sound. For example, the user may hear positive feedback messages, a melody or sounds related to one or more print elements associated with the zone. In some embodiments, the user hears a sound coincident with the drawing of the stroke within the zone. Thus, the user may hear a sound when the writing instrument touches and moves along a sheet of the print medium which ceases when the writing instrument is removed from the sheet. Thus, the sound may mimic a scratching sound of a pencil or a squeaking sound of a marker. In preferred embodiments, the sound includes a purring sound which mimics the sound of a feline purr which has been shown to be pleasing to a human user. In addition, when the writing instrument is erroneously drawing a line or stroke mark outside of the zone 160, the position location system recognizes that the writing instrument is drawing outside the zone and the user hears an appropriate sound. For example, the user may hear feedback messages such as “Uh-Oh!” or “Try Again”.

In some embodiments, the user is intended to create a specific stroke within a zone 160, such a continuous line from the first end 162 to the second end 164 of FIG. 7. To assist in creating such a stroke, the user may receive an audio output when touching the first end 162, another audio output when drawing within the zone, and another audio output when touching the second end 164. Successful execution of each of these steps in a predetermined order can elicit a congratulatory output message heard by the user. Alternatively, if one or more steps are omitted or executed in an undesired order, a coaching output message may be heard by the user.

B. Applications

The above described zones can be applied to a variety of learning mechanisms using the interactive print media apparatus. In most embodiments, the print medium includes print elements related to the zones. The combination of print elements and instructive and engaging outputs induce the user to use writing to enhance the learning process. Writing, reading and listening are all advantageous to the learning process.

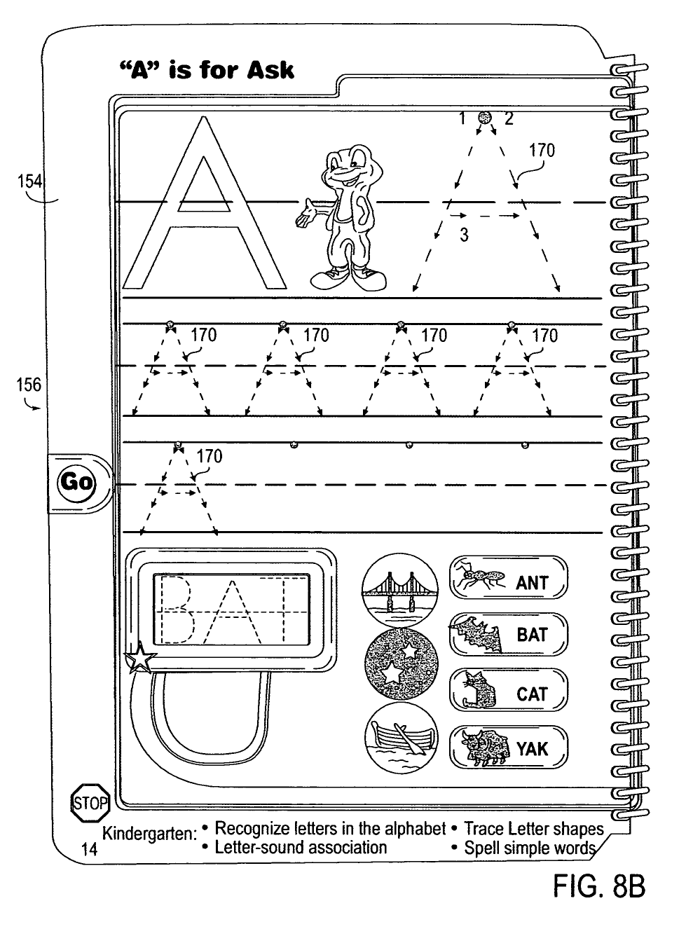

In some embodiments, the print elements include letters of an alphabet and the zones are used to assist the user in the practice of writing the associated letter. FIG. 8A illustrates an embodiment wherein the print element 170 has the shape of the letter “A”. The print element 170 is printed on a sheet of the print medium. In this embodiment, three zones 160′, 160″, 160′″ are shown, each zone overlaying a portion of the letter A. The user may be instructed by an audio output to trace the letter A with the writing instrument. As the writing instrument traces over each portion of the letter, the position location system recognizes that the appropriate stroke is being made in each zone. A variety of audio outputs may be heard during such writing including a purring sound or sounds correlating to the letter shape, such as pronunciation of the letter or the sound of the phoneme, to name a few. In addition, desired handwriting strokes may be taught with the use of such zones. For example, the user may be instructed by audio prompts to begin tracing the letter A by first drawing from top to bottom within zone 160′, then drawing from top to bottom within zone 160″, and then drawing from left to right within zone 160′″. If the user does not write within the zones 160′, 160″, 160′″ following this sequence, the user may receive a variety of audio outputs. Similarly, if the user successfully executes the instructions, a variety of appropriate audio outputs may be heard.

FIG. 8B illustrates an embodiment of a sheet 154 of print medium 156 having print elements 170 such as shown in FIG. 8A. Here the print elements 170 are comprised of dashed lines in the shape of the letter A. The user may be instructed by an audio output to trace the letter A with the writing instrument. As the writing instrument traces over each portion of the letter, the position location system recognizes that the appropriate stroke is being made in each zone.

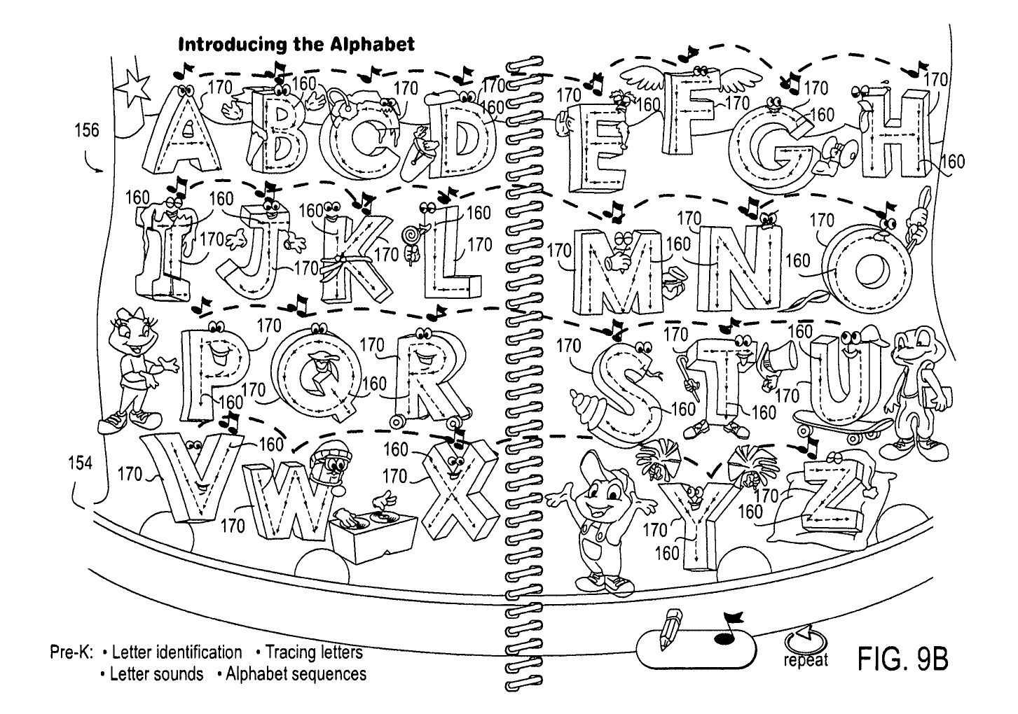

FIG. 9A illustrates a similar embodiment wherein the print element 170 has the shape of the letter “A”. Again, the print element 170 is printed on a sheet of the print medium. In this embodiment, the zone 160 has the shape of the letter A and the print element 170 delineates the shape. Thus, the boundaries of the zone 160 are indicated to the user by the print element 170. The user may be instructed by an audio output to write the letter A with the writing instrument by drawing within the zone 160 having the shape of the letter A. As the writing instrument moves along the zone 160, the position location system recognizes that the appropriate stroke is being made within the zone 160. A variety of audio outputs may be heard during such writing including a purring sound or sounds correlating to the letter shape, such as pronunciation of the letter or the sound of the phoneme, to name a few. Again, desired handwriting strokes may be taught.

FIG. 9B illustrates an embodiment of sheets 154 of print medium 156, each sheet 154 having print elements 170 with shapes of different letters of the English alphabet. Each print element 170 indicates a zone 160 within which the user is intended to draw to write the designated letter of the alphabet. In this example, dashed lines are provided for tracing by the writing instrument within the zones. Again, a variety of audio outputs may be heard during such writing including a purring sound or sounds correlating to the letter shape, such as pronunciation of the letter or the sound of the phoneme, to name a few. In addition, in this example, zones similar to FIG. 7 are provided which are indicated by dashed lines with musical notes. As the writing instrument traces over the dashed lines with musical notes, a melody is heard related to the alphabet.

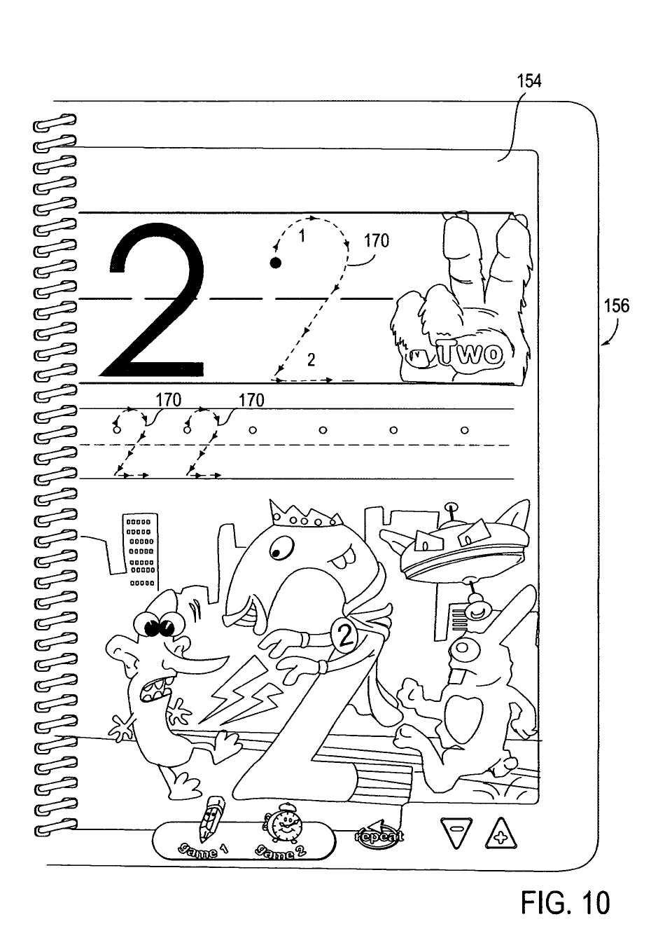

In some embodiments, the print elements include numbers and the zones are used to assist the user in the practice of writing the associated number. FIG. 10 illustrates an embodiment of a sheet 154 of print medium 156 having print elements 170. Here the print elements 170 are comprised of dashed lines in the shape of the number “2”. In this embodiment, one or more zones overlay the number 2 and function similarly to those illustrated in FIGS. 8A-8B. Thus, the user may be instructed by an audio output to trace the number with the writing instrument. As the writing instrument traces over each portion of the number, the position location system recognizes that the appropriate stroke is being made in each zone. A variety of audio outputs may be heard during such writing including a purring sound or sounds correlating to the number shape, such as pronunciation of the number. In addition, desired handwriting strokes may be taught with the use of such zones. For example, the user may be instructed by audio prompts to begin tracing the number 2 by first drawing a curve from top to bottom and then drawing a base from left to right. It may be appreciated that print elements with associated zones as described and illustrated in relation to FIGS. 9A-9B may also be in the form of numbers.

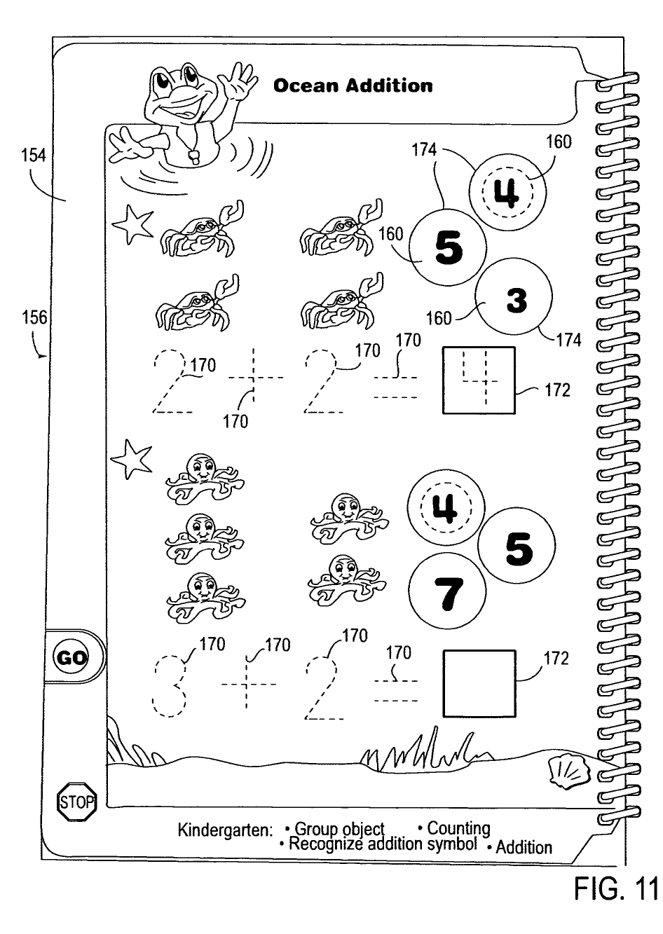

In some embodiments, the print elements include symbols and the zones are used to assist the user in the practice of writing the associated symbol. Such symbols may include mathematical symbols, currency symbols, font symbols, map symbols, and any graphical symbols, to name a few. FIG. 11 illustrates an embodiment of a sheet 154 of print medium 156 having print elements 170. Here the print elements 170 are comprised of dashed lines in the shape of both numbers (2, 3, etc.) and symbols (plus sign, equal sign, etc.). In this embodiment, one or more zones overlay the numbers and symbols and function similarly to those illustrated in FIGS. 8A-8B. Thus, the user may be instructed by an audio output to trace the numbers and symbols with the writing instrument. As the writing instrument traces over each portion of the number, the position location system recognizes that the appropriate stroke is being made in each zone. A variety of audio outputs may be heard during such writing including a purring sound or sounds correlating to the number shape or symbol, such as pronunciation of the number or symbol. By combining numbers and symbols in this fashion, the user is able to use writing reinforcement to learn math. As shown, the print element may comprise a box 172 within which the user is directed to write the answer to an equation in a free form manner. The box 172 is typically comprised of a single zone and writing within the zone produces an audio output such as a purring sound or sounds correlating to the correct number answer. Alternatively, the writing in the box 172 may be correlated to a character by a character recognition system as will be described in later sections. It may be appreciated that print elements with associated zones as described and illustrated in relation to FIGS. 9A-9B may also be in the form of symbols.

FIG. 11 also illustrates the use of zones for selection. Here the print elements include the numbers “3”, “4”, and “5” within bubbles 174. The user is prompted by an audio output to select one of the numbers with the writing instrument. A zone 160 overlays each of the bubbles 174 or extends around each of the numbers with the bubbles 174 so that when a mark is drawn to select one of the numbers, the position location system recognizes that the writing instrument is drawing within the associated zone and recognizes the selection. The selection is then used to provide further audio outputs to lead the user through a learning process or game.

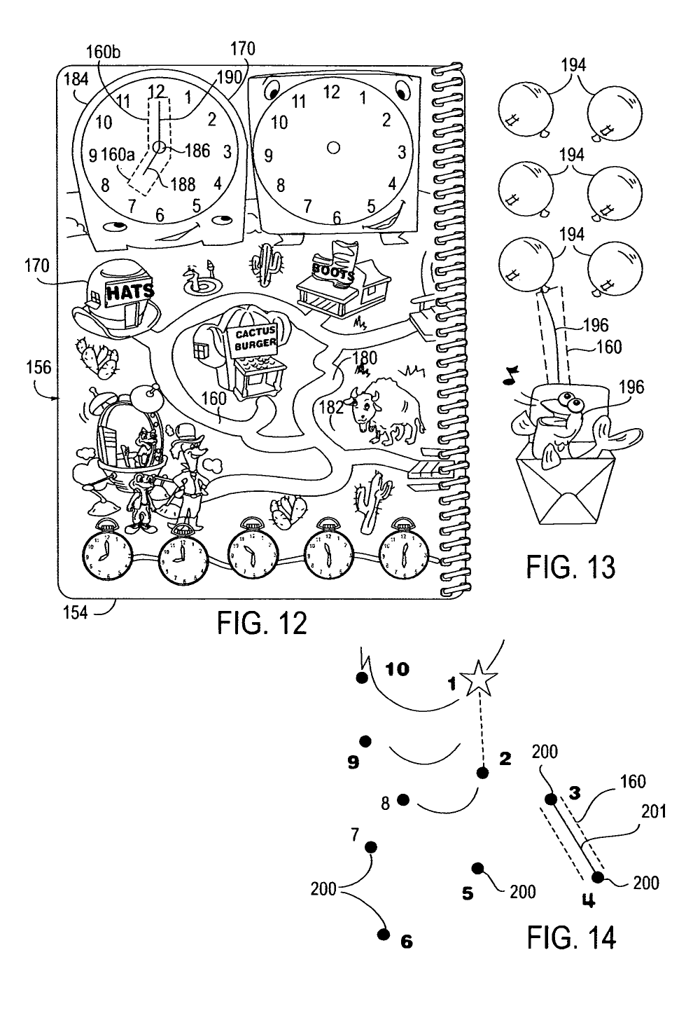

In some embodiments, the zones form one or more pathways and the print elements are used to assist the user in following the pathway with the writing instrument. FIG. 12 illustrates an embodiment of a sheet 154 of print medium 156 having print elements 170. Here the print elements 170 include a maze having pathways 180 and one or more zones 160 overlay the pathways 180. The user is directed to draw a line within the zones 160 through the maze. When the writing instrument is drawing a line or stroke mark within the zone 160, the position location system recognizes that the writing instrument is drawing within the zone and the user hears an appropriate sound. In this embodiment, the user typically hears a sound coincident with the drawing of the stroke within the zone, such as a purring sound. In addition, when the writing instrument is erroneously drawing a line or stroke mark outside of the zone 160, such as in the grassy area 182 of the maze, the position location system recognizes that the writing instrument is drawing outside the zone and the user hears an appropriate sound. For example, the user may hear feedback messages such as “Uh-Oh!” or “Try Again”.

In other embodiments, the zones form pathways between print elements. For example, FIG. 12 also includes print element 170 comprised of a clock face 184. Here, example zones 160a, 160b are indicated by dashed lines; zone 160a extends between the center 186 and number “7” and zone 160b extends between center 186 and number “12”. Thus, the user is directed to draw hands 188, 190 on the clock face 184 indicating a specific time. In this example, the user is instructed by an audio output to draw hands representing 7 o'clock. As shown, the user draws with the writing instrument a small hand 188 within zone 160a and a large hand 190 within zone 160b. When the writing instrument is drawing a line or stroke mark on the clock face 184, the position location system recognizes whether or not the writing instrument is drawing within the correct zones 160a, 160b. The user then receives feedback from the audio output in relation to the writing, such as a congratulatory message if the correct hands are drawn or a coaching message if the correct hands are not drawn. It may be appreciated that zones 160a, 160b are simply exemplary and a plurality of zones are present within the clock face 184, each extending from the center 186 to a number. Thus, the telling time game can be played over and over again with new times being tested.

Other embodiments in which the zones form pathways between print elements are shown in FIGS. 13-14. FIG. 13 includes print elements 170 comprised of a plurality of balloons 194. Here, an example zone 160 is indicated by dashed lines. Thus, the user is directed by an audio output to draw a string 196 extending from a balloon 194 to a creature 196. As shown, the user draws with the writing instrument a line within zone 160. When the writing instrument is drawing a line or stroke mark, the position location system recognizes whether or not the writing instrument is drawing within the zone 160. The user then receives feedback from the audio output in relation to the writing. It may be appreciated that zone 160 is simply exemplary and a plurality of zones are present between the various balloons 194 and the creature 196. Similarly, FIG. 14 includes print elements 170 comprised of a plurality of dots 200. Here, an example zone 160 is indicated by dashed lines. Thus, the user is directed by an audio output to draw a line 201 between the dots 200 to create a picture.

III. Handwriting Recognition

As mentioned, the print medium includes one or more prescribed locations which are areas specifically designated for writing by the user. In some embodiments, when the user creates lines, marks, or stroke marks in the shape of characters within the one or more prescribed locations, the print media apparatus recognizes the characters and provides an audio output. Thus, the apparatus is able to recognize handwritten characters, such as letters, numbers and symbols, which enables a variety of interactive learning exercises and games.

A. Character Recognition

Embodiments of the interactive print media apparatus provide a memory device comprising code for correlating lines, marks, or stroke marks, made with the writing instrument within the prescribed locations, to one or more characters. Any suitable character recognition code may be used. Character recognition software is commercially available from Xpert Eye, Inc. of Sammamish, Wash. (www.experteye.com) and Vision Objects, Inc. of Paris, France. Software such as the type sold by these entities can be used in any of the interactive apparatuses described herein. As noted above, the positions of the described stylus during writing can be determined by the processor in the electrographic position location system. Using the character recognition software, these positions can be translated into specific characters by the processor and specific audio outputs, responses, etc. can be provided to the user after the processor determines the specific characters written by the user.

B. Character Recognition Fields

Character recognition fields are prescribed locations designated for handwriting recognition. The user is intended to draw lines or stroke marks in the form of a character, such as a letter, number or symbol, within the field and the print media apparatus recognizes the character. Fields may have any shape including squares, rectangles, circles, ovals, triangles, stars, polygons, or others. Typically, such fields are delineated or indicated by an appropriate print element. The print element may have any suitable form, such as delineating specific shapes such as squares, rectangles, circles, ovals, triangles, stars, polygons, or others. The shape of a field and a corresponding print element may match or may differ.

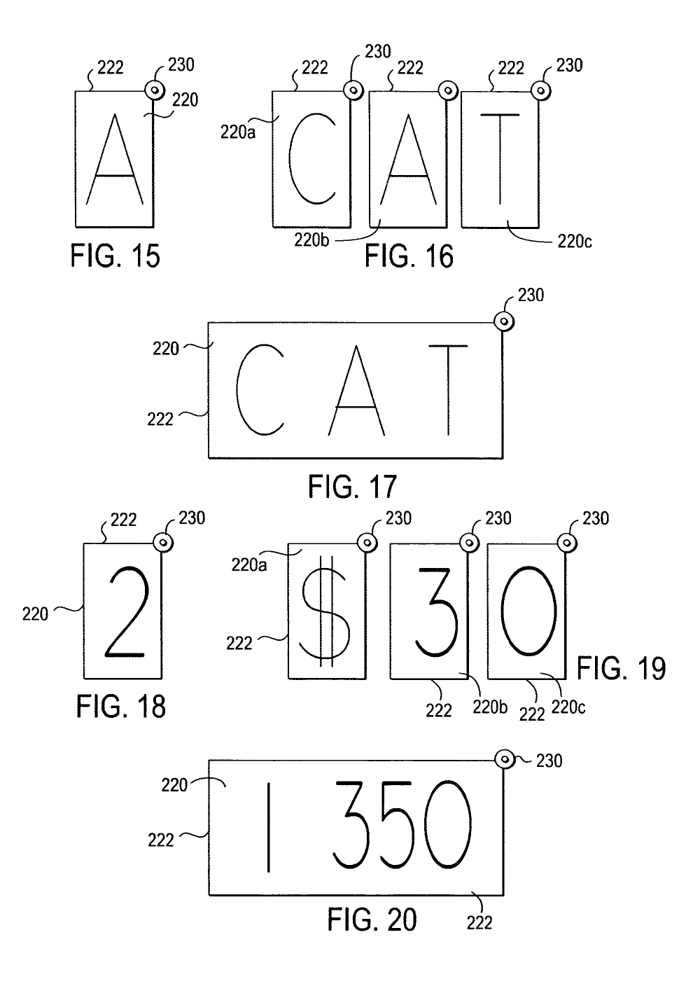

FIG. 15 illustrates an embodiment of a field 220 having a rectangular shape. Here, the field 220 is delineated by a print element (box 222) having a matching rectangular shape. In this embodiment, the letter “A” is shown drawn in the field 220. Drawing of such a letter with the writing element of the stylus 3 allows the print media apparatus 100 to recognize the stroke marks as the letter “A” using the electronic position location system and appropriate software. The output device, operationally coupled to the electronic position location system, then optionally provides an audio or visual output to the user, such as a pronunciation of the letter A or a phrase or song related to the letter. Fields 220 may be arranged in groups, such as aligned in a row as shown in FIG. 16, so that the user may use the individual fields together as a group. In this example, the letters “C”, “A”, “T” are drawn in fields 220a, 220b, 220c respectively so that the user may visualize the word “CAT”. Here, the letters are entered individually and the output device may provide separate output for each letter. But, due to the arrangement of the fields 220a, 220b, 220c, the print media apparatus 100 is able to determine the word spelled by the letters. Alternatively, more than one letter may be drawn in a field 220, as shown in FIG. 17. Here, the letters are entered together into one field 220 to spell the word “CAT”. The print media apparatus 100 may recognize such stroke marks as the word “CAT” and provide an appropriate output, such as a pronunciation of the word “CAT”, the sound of a cat's meow or phrase such as “You spelled the word cat!”.

It may be appreciated that numbers, symbols, and any other characters may be drawn in the fields 220 and recognized by the electronic position location system in the manner described and illustrated in FIGS. 15-17. For example, FIG. 18 illustrates the number “2” drawn in the field 220. Drawing of such a number with the writing element of the stylus 3 allows the print media apparatus 100 to recognize the stroke marks as the number “2” using the electronic position location system. The output device, operationally coupled to the electronic position location system, then optionally provides an audio or visual output to the user, such as a pronunciation of the number 2 or a phrase or song related to the number. Fields 220 may be arranged in groups, such as aligned in a row as shown in FIG. 19, so that the user may use the individual fields together as a group. In this example, the numbers “3” and “0” are drawn in fields 220b, 220c respectively so that the user may visualize the number “30” (thirty) rather than the numbers “3” (three) and “0” (zero). Here, the numbers are entered individually and the output device may provide separate output for each number. But, due to the arrangement of the fields 220b, 220c, the print media apparatus 100 is able to recognize the multi-digit number “30” and appropriate output, such as pronunciation of the word “thirty”. In addition, the symbol “$” (dollar sign) is drawn in field 220a. Due to the arrangement of the fields 220a, 220b, 220c, the print media apparatus 100 is able to recognize the number as a dollar amount and provide an appropriate output, such as pronunciation of the phrase “thirty dollars”. Alternatively, more than one number may be drawn in a field 220, as shown in FIG. 20. Here, the letters are entered together into one field 220 to create the multi-digit number “1350”. The print media apparatus 100 may recognize such stroke marks as the value “1350” and provide an appropriate output, such as a pronunciation of the phrase “one thousand three hundred and fifty”. It may be appreciated that symbols and letters may also be combined with numbers in the field for appropriate recognition.

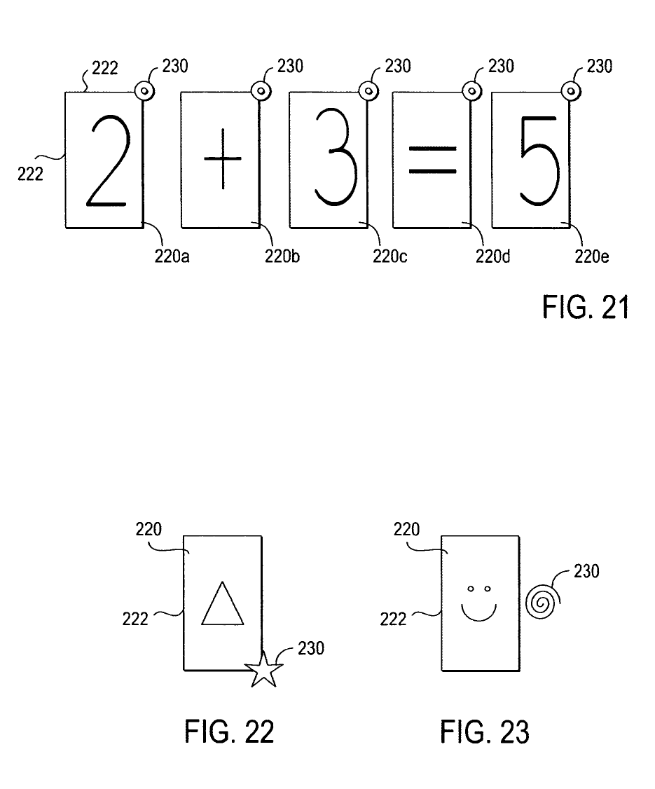

FIG. 21 illustrates the use of fields 220 to perform mathematical computations. Here, five rectangular fields 220a, 220b, 220c, 220d, 220e are shown aligned in a row. Numbers and symbols may be drawn in the fields to represent a mathematical formula. As shown, the number “2” is drawn in field 220a, followed by a plus sign (+) in field 220b, followed by the number “3” in field 220c, followed by an equal sign (=) in field 220d. Drawing of such numbers and symbols with the writing element of the stylus 3 allows the print media apparatus 100 to recognize the stroke marks using the electronic position location system. The output device, operationally coupled to the electronic position location system, then optionally provides an audio or visual output to the user, such as a pronunciation of the numbers and symbols during the creation of the equation. The output may also include prompts to help the user solve the equation. As a result, the user may write the number “5” in field 220e, as shown, which would be recognized as correct and a congratulatory message may be heard. Alternatively, assistance prompts may be heard by the user if an incorrect character is written in the field 220e.

It may be appreciated that a variety of stroke marks may be recognized as known symbols by the print media apparatus 100. Standard typewriter-type symbols, such as an “at” symbol (@), a pound sign (#), a dollar sign ($), a percentage sign (%), an ampersand (&), an asterisk (*), a greater sign (>), and a lesser sign (<), etc., may be used. In addition, select symbols, such as a circle, square, triangle, hexagon, cross, star, sun, moon, house, spiral, happy face, stick figure person, heart, flag, etc., may also be recognized. FIG. 22 illustrates a triangle drawn within field 220 and FIG. 23 illustrates a happy face drawn within field 220.

B. Done Print Elements

It may be appreciated that a plurality of stroke marks may be involved in drawing a particular character. Therefore, to indicate when the user has completed drawing a character in a field, the user selects a print element known as a done print element or a “done dot” which is associated with the field. In some embodiments, selection of the done print element with the stylus activates electrical elements underneath the done print element which signals the print media apparatus 100 to analyze the stroke marks and recognize the marks as a character. In other embodiments, the analysis process begins as soon as the stylus 3 is removed from the field, such as lifted from the writing material. Selection of the done print element with the stylus then retrieves the analysis result. Depending on how quickly the stylus 3 is moved to the done print element, the analysis result will be immediately available or will be available more quickly than if selection of the done print element actuated the analysis. If the user creates another stroke mark instead of touching the done print element, the analysis process is stopped and the results discarded. A new analysis process is then started when the user has removed the stylus 3 from the field after creating the new stroke mark. This analysis process may be referred to as “speculative analysis”. It may be appreciated that any embodiments described herein utilizing done print elements to actuate the analysis process may alternatively use done print elements to retrieve a result with the use of speculative analysis.

Done print elements can have any shape, such as a dot, circle, square, triangle, star, swirl, etc. FIGS. 15-21 illustrate done print elements 230 in the shape of a double circle located at the upper right corner of each of the boxes 222. It may be appreciated that done print elements 230 may be located anywhere on a page of the print medium, preferably near the edge of the associated field, more preferably at top right corner of the field. FIG. 22 illustrates a done print element 230 in the shape of a star located at the lower right corner of the box 222 and FIG. 23 illustrates a done print element 230 in the shape of a swirl located near the right edge of the box 222. Each done print element may be associated with a single field or more than one field. Alternatively or in addition, more than one done print element may be associated with a single field. For example, a field may include three done print elements, one having a form indicating that it is a “letter done print element”, another indicating that it is a “number done print element” and another indicating that it is a “symbol done print element”. After the user draws a character in the field, the done print element is selected which reflects the type of character drawn in the field. This may assist in recognition of the character.

C. Applications

The above described handwriting recognition fields can be applied to a variety of learning mechanisms using the interactive print media apparatus. In most embodiments, the print medium includes print elements related to the fields. The combination of print elements and instructive and engaging outputs induce the user to use writing to enhance the learning process. Writing, reading and listening are all advantageous to the learning process.

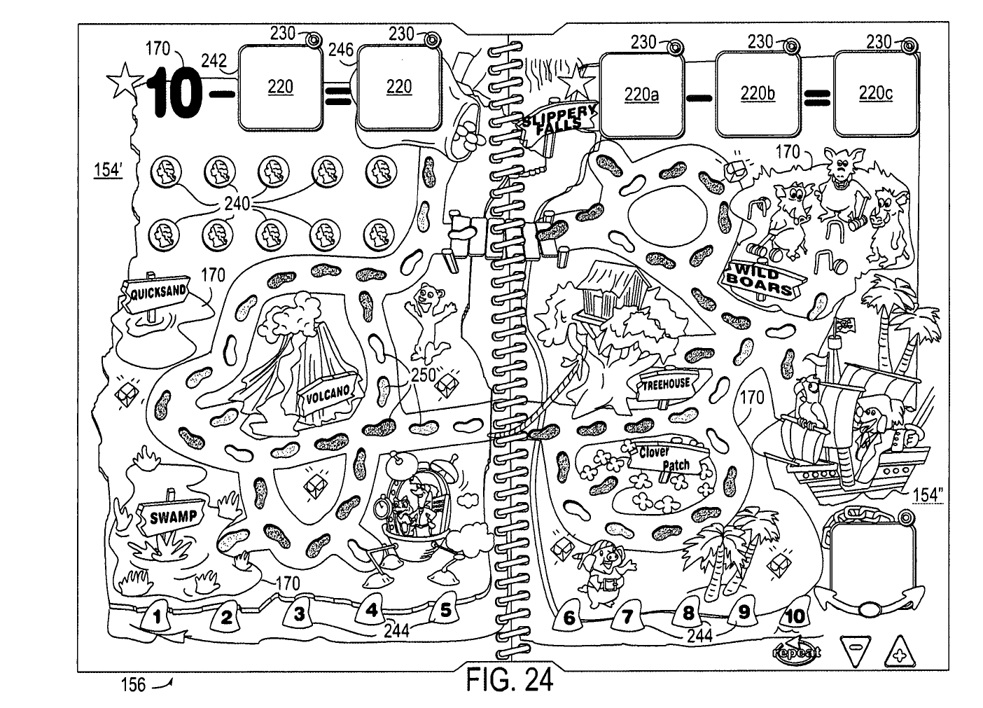

FIG. 24 illustrates an embodiment of two sheets 154′, 154″ of print medium 156 having print elements 170 and character recognition fields 220. Fields 220 disposed along the top edge of the sheets 154′, 154″ are used to generate interactive mathematical equations and the print elements 170 across the sheets are used to assist the user in creating and solving the generated equations. For example, the print elements include ten gold coins 240 shown on sheet 154′. The ten gold coins 240 represent the number “10” printed near the top left corner of the sheet 154′. The user is asked to touch each of the gold coins 240 with the writing instrument. Upon touching a gold coin 240 the output provides a message to the user as to whether the coin is “real” or “fools”. If the coin 240 is “fools” the user is instructed to cross off the coin 240 with the writing element of the writing instrument. Once the user has touched all of the coins 240, the user if prompted to write the number corresponding to the number of coins 240 crossed off in the subtrahend box 242. The subtrahend box 242 indicates a field 220 wherein stroke marks are recognized by the print media apparatus 100. Once the user is finished writing the number in the subtrahend box 242, the user touches the associated done print element 230. If the apparatus 100 recognizes the number as the correct number, an associated phrase may be heard, such as a pronunciation of the number. If the apparatus 100 recognizes the number as the incorrect number, a coaching message may be heard. If the stroke marks are inconsistent and do not form a recognizable character, the user is prompted to select the intended number from a number line 244 present on the print medium 156.

The user is then prompted to solve the mathematical equation generated by the number “10” and the number written in the subtrahend box 242. The user writes the answer in the equals box 246. The equals box 246 indicates a field 220 wherein stroke marks are recognized by the print media apparatus 100. Once the user is finished writing the answer in the equals box 246, the user touches the associated done print element 230. If the apparatus 100 recognizes the number as the correct number, a congratulatory message may be heard. If the apparatus 100 recognizes the number as the incorrect number, a coaching message may be heard. Again, if at any time the stroke marks are inconsistent and do not form a recognizable character, the user is prompted to select the intended number from a number line 244 present on the print medium 156.

In another example, fields 220 disposed along the top edge of the sheet 154″ are used to generate an interactive mathematical equation and the print elements 170 across the sheets are used to assist the user in creating and solving the generated equation. Here, the print elements include a maze having footprints 250. The user is instructed to find a hidden treasure by making steps along the footprints 250 of the maze. To begin, the user is prompted to select a starting point, such as a volcano 252. The user is then prompted to write a number in the first field 220a. The user is then prompted to write a number in the second field 220b. The user is then prompted to solve the mathematical equation by writing the answer in the third field 220c. If the apparatus 100 recognizes the number as the correct number, a congratulatory message may be heard. If the apparatus 100 recognizes the number as the incorrect number, a coaching message may be heard. Once the correct answer has been written, the user is prompted to make a corresponding number of steps along the footprints 250. Such sequence may be repeated until the treasure is found.

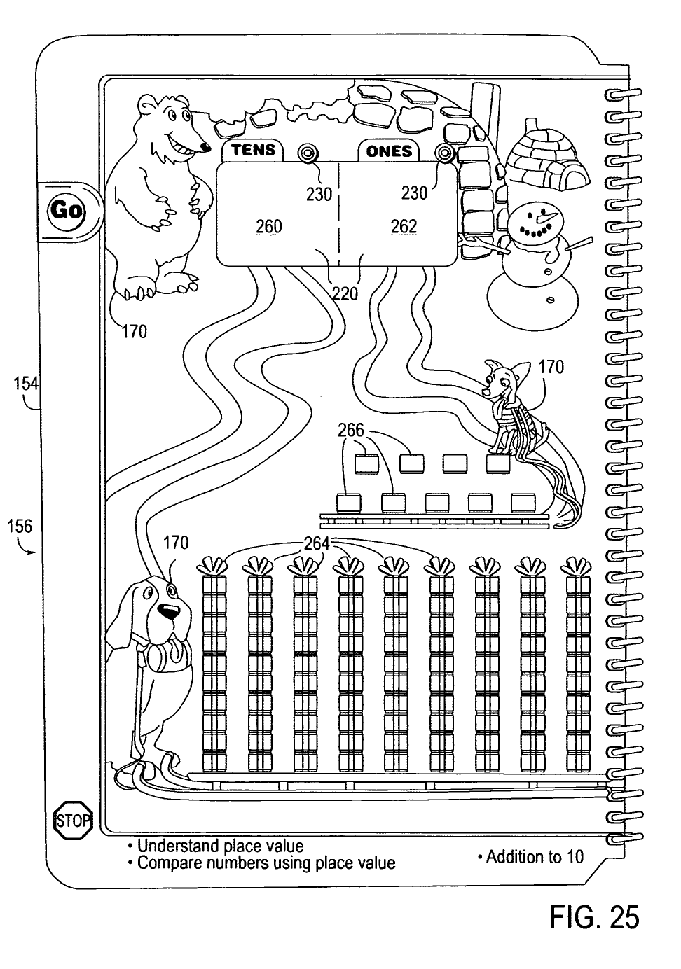

FIG. 25 illustrates an embodiment of a sheet 154 of print medium 156 having print elements 170 and character recognition fields 220. The fields include a “tens” field 260 and a “ones” field 262 which are indicated near the top of the sheet 154. The user is provided with a message such as “The polar bear needs twenty seven ice cream sandwiches! Touch stacks of ten ice cream sandwiches on the big dog's sled until you have twenty.” Thus, the user is instructed to touch two stacks 264 with the writing instrument. Once completed, the user receives an output such as “Write the number two in the tens place on the igloo.” The user then writes the number two in the tens field 260 with the writing element of the writing instrument. Upon selection of the done print element 230, the apparatus 100 recognizes the number written in the tens field 260. If the number is correct, a message may be heard, such as “Two in the tens place means twenty!” If the apparatus 100 recognizes the number as the incorrect number, a coaching message may be heard. The user then receives an output such as “Touch seven ice cream sandwiches on the little dog's sled.” Thus, the user is instructed to touch seven blocks 266 with the writing instrument. Once completed, the user receives an output such as “Write the number seven in the ones place on the igloo.” The user then writes the number seven in the ones field 262 with the writing element of the writing instrument. Upon selection of the done print element 230, the apparatus 100 recognizes the number written in the ones field 262. If the number is correct, a message may be heard, such as “Two tens and seven ones make twenty seven ice cream sandwiches!” If the apparatus 100 recognizes the number as the incorrect number, a coaching message may be heard. This sequence may be repeated with any numbers to provide a large variety of games.

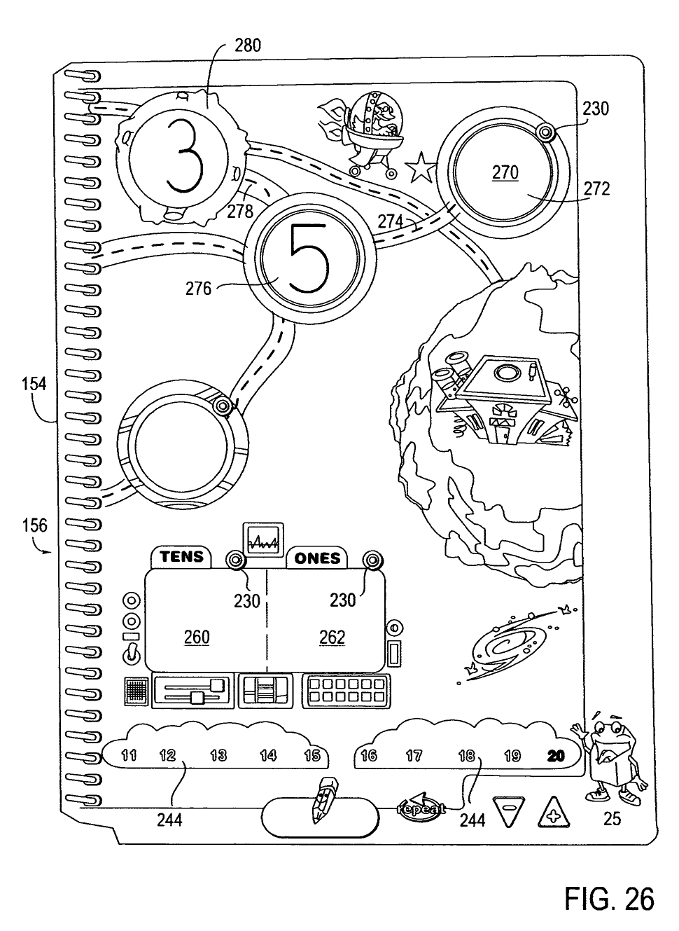

FIG. 26 illustrates another embodiment of a sheet 154 of print medium 156 having print elements 170 and character recognition fields 220. Again, the fields include a “tens” field 260 and a “ones” field 262 which are indicated near the bottom left side of the sheet 154. In addition, at least one input field 270 is provided, indicated by a circle 272. The user is provided with a message such as “Nine passengers want a ride on the brown planet. Write the number nine.” Thus, the user is instructed to write the number nine in the input field 270. Upon selection of the done print element 230, the apparatus 100 recognizes the number written in the input field 270. If it is correct, the user is prompted to trace the dashed line 274 to the circular print element 276 containing the number five. The user then hears a message such as “Five more passengers want a ride. Five plus nine equals how many? Touch your answer at the bottom of the page.” Once the user touches the number fourteen on the number line 244, the user is prompted to trace the dashed line 278 to the circular print element 280 containing the number three and hears a message such as “Three more passengers want a ride. Fourteen plus three equals how many? Touch your answer at the bottom of the page.” Once the user touches the number seventeen on the number line 244, the user is instructed to write the number one in the tens field 260 and a number seven in the ones field 262. Upon selection of the done print elements 230, the apparatus 100 recognizes the numbers written in the fields 260, 262. If the numbers are correct, a message may be heard, such as “Seventeen! Awesome! You drove seventeen people home!” If the apparatus 100 recognizes the numbers as incorrect, a coaching message may be heard. This sequence may be repeated with any numbers to provide a large variety of games.

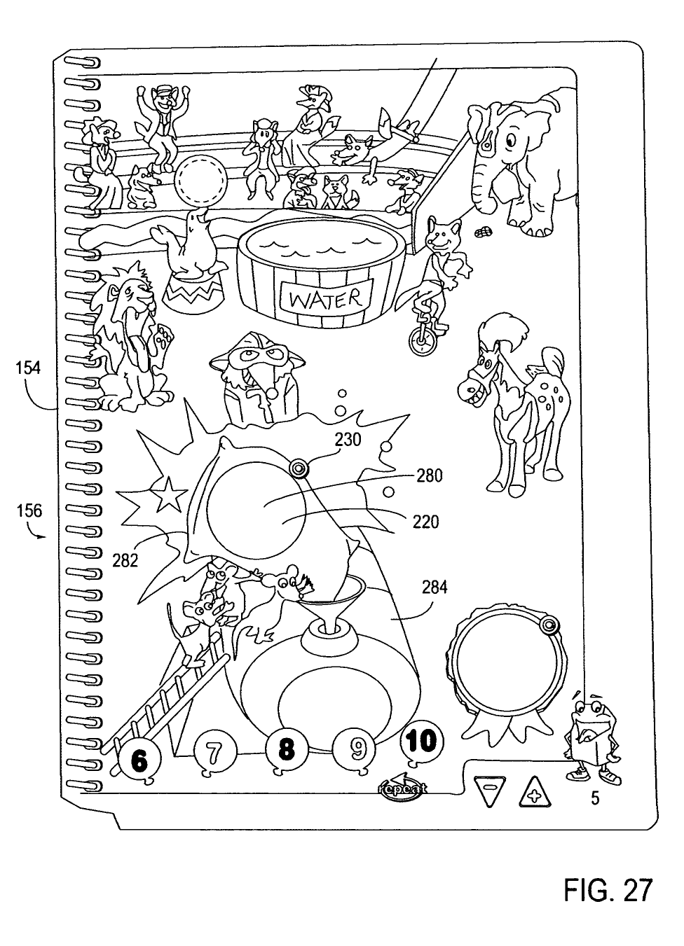

FIG. 27 illustrates another embodiment of a sheet 154 of print medium 156 having print elements 170 and a character recognition field 220. Here, a field 220 is provided indicated by a circular print element 280 on a picture of an ammunition bag 282 loading a cannon 284. The user is provided with a message such as “Guess the number sugar cubes it takes to launch the cannon ball into the tub of water. In the brown circle write a number between one and nine.” Thus, the user is instructed to write a number, such as six, in the field 220. Upon selection of the done print element 230, the apparatus 100 recognizes the number written in the field 220 as the number six. The user may then hear another prompt such as “The number of sugar cubes to launch the cannon is less than six. In the brown circle write a number less than six.” Thus, the user is instructed to erase the number previously written in the field and write a new number, such as two, in the field 220. Upon selection of the done print element 230, the apparatus 100 recognizes the number written in the field 220 as the number two. The user may then hear another prompt such as “The number of sugar cubes to launch the cannon is greater than two and less than six. In the brown circle write a number greater than two and less than six.” This pattern may be repeated until the user guesses the correct answer and writes the correct number in the field 220, wherein the user hears a congratulatory message.

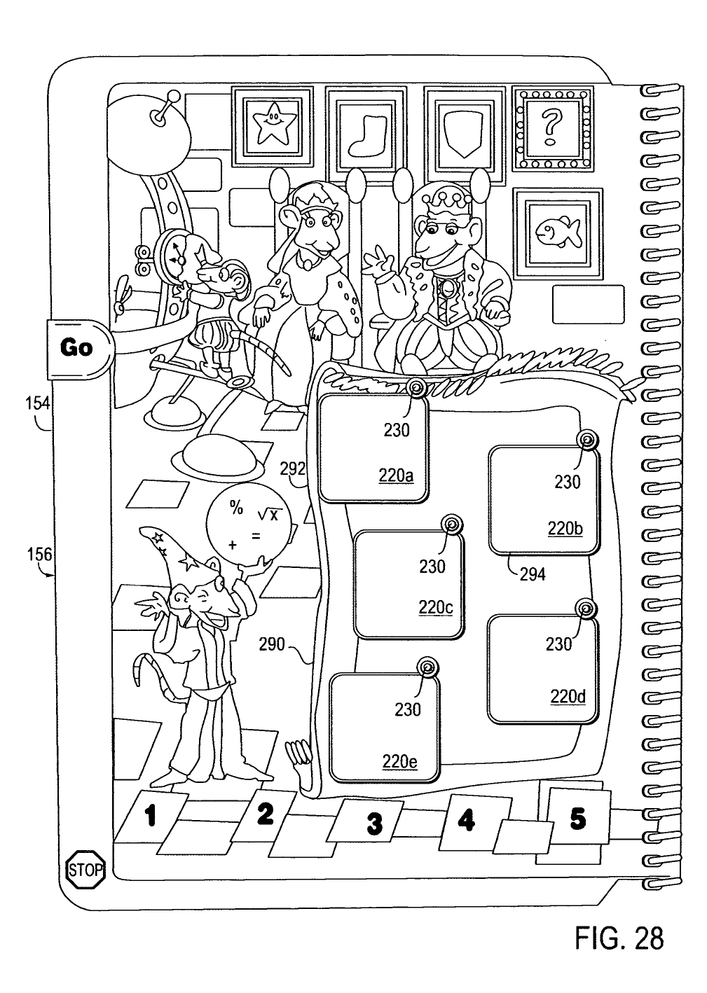

FIG. 28 illustrates another embodiment of a sheet 154 of print medium 156 having print elements 170 and character recognition fields 220a, 220b, 220c, 220d, 220e. Here, the fields 220a, 220b, 220c, 220d, 220e are provided on a picture of a magic carpet 290. The user is provided with a message such as “Answer questions to hear your fortune. Touch a white square on the magic carpet.” Thus, the user is instructed to touch one of the fields 220a, 220b, 220c, 220d, 220e with the writing instrument. In this example, the user touches field 220a which is delineated by an orange square 292. The user then hears a message such as “How many sisters do you have? Write your answer in the orange square.” Thus, the user is instructed to write a number, such as two, in the field 220a. Upon selection of the done print element 230, the apparatus 100 recognizes the number written in the field 220a as the number two. The user may then hear another audio output, such as “Two!”, indicating that the apparatus 100 has recognized the written number. The user then hears a message such as “Touch another white square on the magic carpet.” In this example, the user touches field 220b which is delineated by a green square 294. The user then hears a message such as “How many cupcakes do you want for breakfast? Write your answer in the green square.” Thus, the user is instructed to write a number, such as four, in the field 220b. Upon selection of the associated done print element 230, the apparatus 100 recognizes the number written in the field 220b as the number four. The user may then hear another audio output, such as “Four!”, indicating that the apparatus 100 has recognized the written number. This pattern may be repeated until answers are written in each of the fields 220a, 220b, 220c, 220d, 220e. The user may then hear a fortune based on the answers written in the fields 220a, 220b, 220c, 220d, 220e, such as “You will live a long happy life with your two sisters eating four cupcakes every morning, etc.”. Alternatively, the answers may be used to test the user's mathematical skills. For example, the user may hear a message such as “Cross off the white square that contains the number equal to three plus one”. Thus, apparatus 100 has stored the recognized numbers and uses the numbers to further test the user. The user then crosses off the number four written in field 220b. This may be repeated any number of times. The user may then hear a fortune based on the answers written in the remaining fields which were not crossed off.

Although the foregoing invention has been described in some detail by way of illustration and example, for purposes of clarity of understanding, it will be obvious that various alternatives, modifications and equivalents may be used and the above description should not be taken as limiting in scope of the invention which is defined by the appended claims. Moreover, any one or more features of any embodiment may be combined with any one or more features of any other embodiment without departing from the scope of the invention.

Also, it should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

All references, patent applications, and patents mentioned above are herein incorporated by reference in their entirety for all purposes. None of them are admitted to be prior art to the presently claimed inventions.

1. An interactive print media apparatus comprising:
a platform having a surface configured to receive a sheet, wherein the sheet includes at least one prescribed location;
an electronic position location system comprising a processor;
a writing instrument operatively coupled with the electronic position location system; and
a memory device operatively coupled to the processor, the memory device comprising code for at least one output wherein the at least one output relates to drawing of a stroke mark with the writing instrument within the at least one prescribed location on the sheet.

2. An apparatus as in claim 1, wherein the at least one output includes a sound that is heard by a user coincident with the drawing of the stroke mark.

3. (canceled)

4. An apparatus as in claim 1, wherein the sheet includes at least one print element corresponding to the at least one prescribed location.

5. An apparatus as in claim 4, wherein the at least one print element comprises a pathway wherein the pathway corresponds to the at least one prescribed location.

6. An apparatus as in claim 5, wherein the at least one output includes a sound correlating to the pathway.

7-8. (canceled)

9. An apparatus as in claim 4, wherein the at least one print element comprises a letter shape, a number shape or a symbol shape corresponding to the at least one prescribed location.

10. An apparatus as in claim 9, wherein the at least one output includes a sound relating to the letter shape, number shape or symbol shape.

11-14. (canceled)

15. An apparatus as in claim 1, wherein the at least one output indicates drawing of a stroke mark with the writing instrument outside of the at least one prescribed location on the sheet.

16. (canceled)

17. An interactive print media apparatus comprising:
a platform having a surface configured to receive a sheet, the sheet including at least one prescribed location;
an electronic position location system comprising a processor;
a writing instrument operatively coupled with the electronic position location system; and
a memory device operatively coupled to the processor, the memory device comprising code for correlating drawing of stroke marks with the writing instrument within one of the at least one prescribed locations to a character and for at least one output relating to the character.

18. An apparatus as in claim 17, wherein the character comprises a letter, number, or symbol.

19. An apparatus as in claim 18, wherein the code provides a sound related to the character.

20-23. (canceled)

24. An apparatus as in claim 17, wherein the code correlates the drawing of stroke marks in response to disengaging the writing instrument from the sheet.

25. An apparatus as in claim 24, wherein the memory device further comprises code for retrieving a correlation result in response to selection of a done print element on the sheet by the user with the writing instrument.

26. An apparatus as in claim 17, wherein the code correlates the drawing of stroke marks in response to selection of a done print element on the sheet by the user with the writing instrument.

27. (canceled)

28. An apparatus as in claim 17, wherein the memory device comprises code which correlates characters drawn within a plurality of prescribed locations to one or more words.

29. An apparatus as in claim 28, wherein the memory device comprises code for at least one sound comprising a pronunciation of the one or more words.

30. An apparatus as in claim 28, wherein the memory device comprises code for correlating the characters in response to selection of a done print element on the sheet by the user with the writing instrument.

31-32. (canceled)

33. An apparatus as in claim 17, wherein the sheet includes at least one print element corresponding to the at least one prescribed location.

34-36. (canceled)

37. A method of using an interactive print media apparatus comprising a platform having a surface, an electronic position location system comprising a processor, and a sheet including at least one prescribed location, wherein the sheet is mountable on the surface of the platform, the method comprising:
drawing a stroke mark with a writing instrument within the at least one prescribed location on the sheet; and
receiving an output in response to the drawing of the stroke mark indicating that the drawing is within the at least one prescribed location.

38. A method as in claim 37, wherein the output comprises a sound that is heard coincident with the drawing of the stroke mark.

39. (canceled)

40. A method as in claim 37, wherein the sheet includes at least one print element comprising a pathway wherein the pathway indicates the at least one prescribed location, and wherein drawing the stroke mark comprises drawing a line along the pathway.

41. (canceled)

42. A method as in claim 37, wherein the sheet includes at least one print element comprising a letter shape, a number shape or a symbol shape delineating the at least one prescribed location, and wherein the output comprises a sound correlating to the letter shape, number shape or symbol shape.

43-46. (canceled)

47. A method of using an interactive print media apparatus comprising a platform having a surface, an electronic position location system comprising a processor, a sheet including at least one prescribed location which is mountable on the surface of the platform, and a memory device operatively coupled to the processor, the memory device comprising code for correlating stroke marks to a character and at least one output, the method comprising:
drawing the stroke marks with a writing instrument within the at least one prescribed location on the sheet for the memory device to correlate the stroke marks to the character; and
receiving an output in response to the drawing of stroke marks indicating the character.

48. A method as in claim 47, wherein drawing the stroke marks comprise drawing a letter, number, or symbol.

49. A method as in claim 47, wherein receiving the output comprises receiving a sound related to the character.

50-53. (canceled)

54. A method as in claim 47, further comprising selecting a done print element on the sheet with the writing instrument, wherein selecting causes the memory device to correlate the stroke marks to the character.

55. A method as in claim 54, wherein selecting the done print element causes the memory device to correlate characters drawn within a plurality of prescribed locations to one or more words.

56. (canceled)

57. A method as in claim 54, wherein selecting the done print element causes the memory device to correlate characters drawn within a plurality of prescribed locations to one or more numbers.

58. A method as in claim 54, wherein the memory device comprises code for recognizing handwriting.
